(19) United States
(12) Patent Application Publication
(10) Pub. No.: US 2014/0302290 A1
(43) Pub. Date: Oct. 9, 2014

(54) RECORDED MATTER, RECORDING METHOD, AND IMAGE PROCESSING METHOD

(71) Applicant: CANON KABUSHIKI KAISHA, Tokyo (JP)

(72) Inventors: Rie Takekoshi, Kawasaki-shi (JP); Takumi Kaneko, Tokyo (JP); Kazuki Narumi, Komae-shi (JP); Ayumi Hirakawa, Kawasaki-shi (JP); Yumi Kamimura, Inagi-shi (JP)

(21) Appl. No.: 14/355,713

(22) PCT Filed: Nov. 1, 2012
(86) PCT No.: PCT/JP2012/078909

§ 371 Date: May 1, 2014

(30) Foreign Application Priority Data
Nov. 2, 2011 (JP) 2011-241439

(51) Int. Cl. B41M 5/50; B41J 2/21

(52) U.S. Cl. CPC B41M 5/502; B41J 2/21
USPC 428/204; 347/20; 347/9; 428/203

(57) ABSTRACT

A recorded matter recorded on a recording medium includes a first layer formed by an ink A on or above the recording medium, the first layer having an index of refraction A; a second layer formed by an ink B on the first layer formed by the ink B, the second layer having an index of refraction B (where B<A); and a third layer formed by an ink C or by a transparent resin material on the second layer, the third layer having an index of refraction C (where C>A) and forming a surface layer of the recorded matter.

### TECHNICAL FIELD

The present invention relates to a recorded matter, a recording method, and an image processing method.

### BACKGROUND ART

Recent advances in manufacturing technology have enabled the development of pigment ink with both excellent long-term preservability, which is an intrinsic characteristic of pigment ink, and high color developability comparable to that of dye ink. For this reason, pigment ink has been used in image recording with requirements of the long-term preservation of recorded images, such as photographs and posters.

However, the use of pigments in the applications described above may cause inherent image quality problems such as a glossiness variation in which the glossiness of an image is likely to become non-uniform and bronzing when using, in particular, pigment cyan ink, which do not arise in film photography.

Bronzing is a phenomenon where illuminating light is reflected as a color different from the color of the illuminating light when specularly reflected (or mirror-reflected) from a surface of a pigment image. It is known that bronzing occurs noticeably, in particular, with cyan ink.

To address the above-described image quality problems of glossiness variation, bronzing, and low durability, a technology for partially or fully coating a surface of an image with a transparent processing liquid containing, for example, a resin is disclosed in PTL 1.

### CITATION LIST

### Patent Literature

PTL 1 Japanese Patent Laid-Open No. 2005-0074601

### SUMMARY OF INVENTION

In an aspect, the present invention provides a recorded matter recorded on a recording medium. The recorded matter includes a first layer formed by an ink A on or above the recording medium, the first layer having an index of refraction A; a second layer formed by an ink B on the first layer formed by the ink B, the second layer having an index of refraction B, where B<A; and a third layer formed by an ink C or by a transparent resin material on the second layer, the third layer having an index of refraction C, where C>A, the third layer forming a surface layer of the recorded matter.

Further features of the present invention will become apparent from the following description of exemplary embodiments with reference to the attached drawings.

### BRIEF DESCRIPTION OF DRAWINGS

FIG. 1 is a perspective view illustrating a main part of an inkjet recording apparatus according to an embodiment of the present invention.

FIG. 2A is a diagram of recording heads used in a first embodiment of the present invention, when viewed from the ejection port side.

FIG. 2B is a diagram of recording heads used in a second embodiment of the present invention, when viewed from the ejection port side.

FIG. 2C is a diagram of recording heads used in a third embodiment of the present invention, when viewed from the ejection port side.

FIG. 3 is a schematic block diagram of an inkjet recording apparatus according to an exemplary embodiment of the present invention.

FIG. 4 is a flowchart of processing performed by an image processing unit according to the first embodiment of the present invention.

FIG. 5 is an explanatory diagram of a recording method according to the first embodiment of the present invention.

FIG. 6 is a diagram illustrating a method for measuring bronzing caused by pigment ink on a recording medium.

FIGS. 7A and 7B are diagrams illustrating a difference in interference when a processing liquid is dropped on magenta ink and cyan ink, respectively, for which the differences in index of refraction from the processing liquid are different.

FIG. 8 is a diagram illustrating surface roughness (Ra).

FIG. 9 is a diagram illustrating mask patterns used when a normal pigment ink is applied.

FIGS. 10A and 10C are diagrams illustrating mask patterns for recording in the second half scans, and FIG. 10B is a diagram illustrating mask patterns for recording in when an image is recorded through the first half scans.

FIG. 11 is a diagram illustrating the results of simulating what surface roughness (Ra) the surface of the ink layer would need to exhibit to make interference colors vary and cancel out each other.

FIG. 12 is a diagram illustrating an index pattern.

FIG. 13 is a diagram illustrating index patterns and dot arrangements used in the second embodiment of the present invention.

FIGS. 14A and 14B are diagrams illustrating dot arrangements according to the second embodiment and a third embodiment of the present invention, respectively.

FIG. 15 is a schematic cross-sectional view of a recorded matter according to an embodiment of the present invention, taken along a plane perpendicular to a recording medium diagram.

### DESCRIPTION OF EMBODIMENTS

Exemplary embodiments of the present invention will be described in detail hereinafter with reference to the drawings. The following description will be made in the context of a recording apparatus that uses an inkjet recording method, by way of example. The recording apparatus may be, for example, a single-function printer having only a recording function, or may be a multi-function printer having multiple functions such as a recording function, a facsimile function, and a scanner function. The recording apparatus may also be an apparatus for fabricating a device such as a color filter, an electronic device, an optical device, or a microstructure using a predetermined recording method.

In the following description, the term “recording” is used to refer to not only forming of meaningful information such as characters and figures but also forming of other information regardless of whether it is meaningful or not. The term “recording” is further used to refer to forming of a wide variety of objects such as images, designs, patterns, and structures on a recording medium, regardless of whether or not the objects are made to appear so as to be visually perceptible to the human eye, or to processing of a medium.

The term “recording medium” refers to not only paper, which is generally used in a recording apparatus, but also any material that can receive ink, such as cloth, a plastic film, a metal plate, a glass, a ceramic, a resin, a wood, and a leather.

The term “ink” should be interpreted in a sense as broad as the term “recording”. Accordingly, the term “ink” refers to a liquid that is applied to a recording medium to form objects such as images, designs, and patterns, to process the recording medium, or to process ink (for example, coagulate or make insoluble a colorant in the ink applied to the recording medium).

The term “ink having characteristics for image improvement” refers to ink that improves image performance such as image durability or quality. The term “processing liquid” refers to a liquid (image-performance improving liquid) that is brought into contact with ink to improve image performance such as image durability or quality.

As used here, the term “improving image durability” refers to improving at least one of scratch resistance, weather resistance, water resistance, and alkali resistance to improve the durability of an ink image. The term “improving image quality” means improving at least one of glossiness, haziness properties, and anti-bronzing properties to improve the quality of an ink image.

“Scratch resistance” is evaluated using the minimum load measured on the basis of the method defined in JIS K 5600-5-5. The term “improving scratch resistance” means “increasing the minimum load value”.

“Weather resistance” is evaluated using the degree (or class) of change measured on the basis of the method defined in JIS K 5600-7. For example, a color difference or the like is used as a measure of the degree of change in color. The term “improving weather resistance” means “reducing the degree (or class) of change”.

“Water resistance” and “alkali resistance” are evaluated through the observation of signs of damage measured on the basis of the method defined in JIS K 5600-6-1. The term “improving water resistance” means “reducing signs of damage”.

“Glossiness” is evaluated using the degree of glossiness measured on the basis of the method defined in JIS K 5600-4-7. The term “improving glossiness” means “increasing the gloss value”.

The “haziness properties” are evaluated using the haze value measured on the basis of the method defined in JIS K 7374. The term “improving haziness properties” means “reducing the haze value”.

The “anti-bronzing properties” are evaluated using chromaticity measured on the basis of the method defined in JIS K 0115. The term “improving anti-bronzing properties” means “making chromaticity appear achromatic”.

### First Embodiment

### Overall Configuration

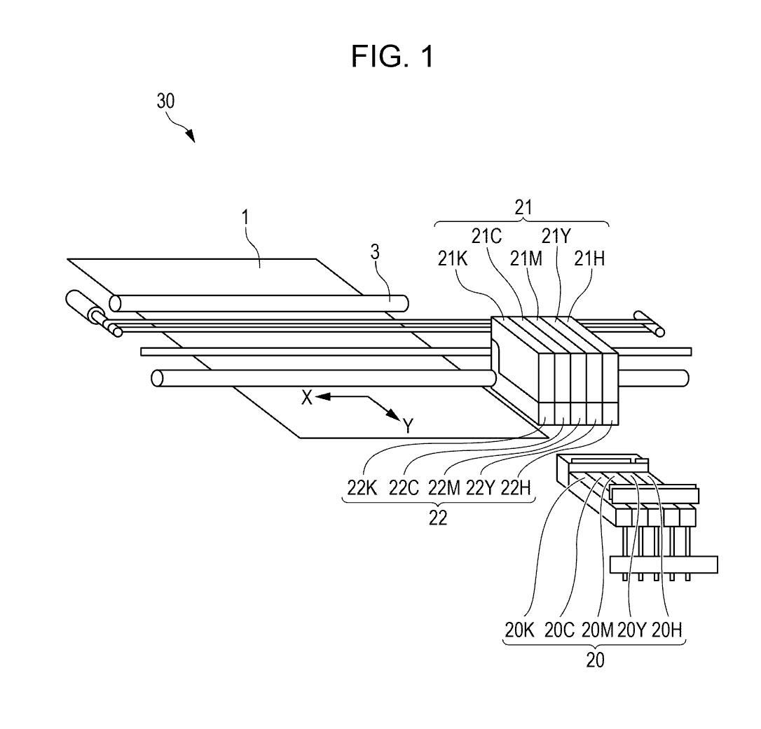

A first embodiment will be described. FIG. 1 is a perspective view illustrating an example configuration of an inkjet recording apparatus (hereinafter referred to as the recording apparatus) 30 according to an embodiment of the present invention.

Recording heads 22 include five recording heads 22K, 22C, 22M, 22Y, and 22H that respectively eject a plurality of kinds (black (K), cyan (C), magenta (M), yellow (Y), and processing liquid (H)) of liquid droplets. Each of the recording heads 22 has ejection ports from which liquid droplets (ink or processing liquid) are ejected onto a recording medium 1 to perform recording.

Tanks 21 are used to supply the respective inks and the processing liquid to the recording heads 22K, 22C, 22M, 22Y, and 22H. The tanks 21 include five tanks 21K, 21C, 21M, 21Y, and 21H that contain the inks corresponding to the respective colors and the processing liquid. The recording heads 22 and the tanks 21 are configured to be scanned a plurality of times in a main scanning direction (direction indicated by an arrow X). In this embodiment, the tanks 21 of the inks corresponding to the respective colors contain pigment inks. The processing liquid is used to form a transparent layer on the outermost surface of pigment ink layers (hereinafter referred to as the “ink layers”) formed on or above the recording medium 1 using the pigment inks. Forming a transparent layer formed of the processing liquid on the outermost surface of the ink layers can improve image durability, namely, scratch resistance.

Caps 20 include five caps 20K, 20C, 20M, 20Y, and 20H for covering the ejection surfaces of the five recording heads 22K, 22C, 22M, 22Y, and 22H, respectively. During a non-recording operation, the recording heads 22 and the tanks 21 stand by at the home position at which they are provided with the caps 20. When the recording heads 22 stand by at the home position for a certain period of time, the recording heads 22 are covered by the caps 20 to prevent the ejection surfaces (the surfaces where the ejection ports are formed) of the recording heads 22 from drying out.

While the recording heads, tanks, and caps are individually identified by the reference numerals assigned thereto, the recording heads, tanks, and caps are generally identified by reference numerals “22”, “21”, and “20”, respectively. The recording heads 22 and the tanks 21 may be formed integrally or separably.

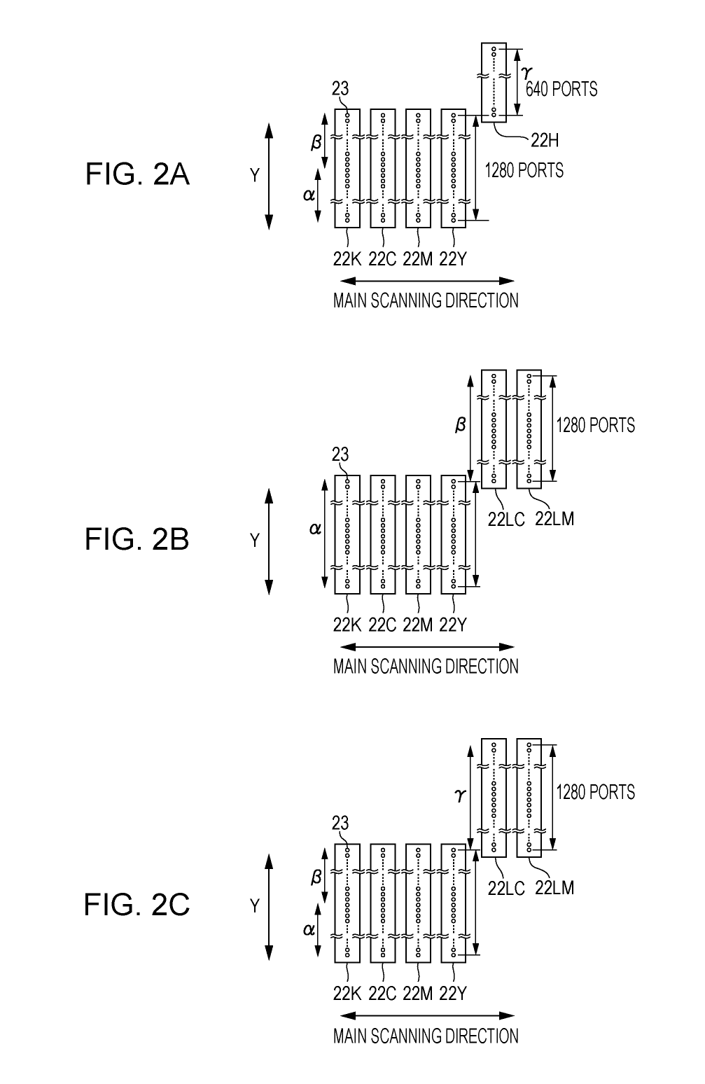

FIG. 2A is a diagram of the recording heads 22 when viewed from the ejection port side. Each of the recording heads 22K, 22C, 22M, and 22Y has 1280 ejection ports 23 formed at a density of 1200 dots per inch (dpi) in a direction (sub-scanning direction: direction indicated by an arrow Y) crossing the main scanning direction, and has a row of ejection ports 23 of the corresponding color. The recording head 22H is arranged so as to be shifted downstream in a recording medium conveying direction along the sub-scanning direction (direction indicated by the arrow Y) with respect to the recording heads 22K, 22C, 22M, and 22Y, and has 640 ejection ports 23. The amount of ink ejected with a single operation from each ejection port 23 is, for example, approximately 4.5 ng.

### Composition of Ink

Next, a description will be made of the composition of the inks and processing liquid used in this embodiment. Hereinafter, “parts” and “%” will be on mass basis unless otherwise stated.

### Black Ink

### (1) Preparation of Dispersion Liquid

First, anionic polymer P-1 [styrene/butyl acrylate/acrylic acid copolymer (polymerization ratio (weight ratio)=30/40/30) having an acid value of 202 and a weight-average molecular weight of 6500 was neutralized with an aqueous solution of potassium hydroxide, and was diluted with ion-exchanged water to make a homogeneous 10 mass % aqueous polymer solution.

After 600 g of the polymer solution, 100 g of carbon black, and 300 g of ion-exchanged water were mixed and mechanically stirred for a predetermined period of time, the mixture was centrifuged to remove an undispersed material including coarse particles to prepare a black dispersion liquid. The obtained black dispersion liquid had a pigment concentration of 10 mass %.

### (2) Preparation of Ink

Ink was prepared by using the black dispersion liquid. The following components were added to the black dispersion liquid to obtain a desired concentration. The components were sufficiently mixed and stirred, and then filtered under pressure by a microfilter with a pore size of 2.5 μm (manufactured by Fuji Photo Film Co., Ltd.) to prepare a pigment ink having a pigment concentration of 5 mass %.

Black dispersion liquid: 50 parts

Glycerin: 10 parts

Triethylene glycol: 10 parts

Acetylene glycol ethylene oxide (EO) adduct (manufactured by Kawaken Fine Chemicals Co., Ltd.):
0.5 parts

Ion-exchanged water: 29.5 parts

### Cyan Ink

### (1) Preparation of Dispersion Liquid

First, an AB block polymer having an acid value of 250 and a number-average molecular weight of 3000 was prepared using benzyl acrylate and methacrylic acid as raw materials in accordance with a usual method. The AB block polymer was then neutralized with an aqueous solution of potassium hydroxide, and was diluted with ion-exchanged water to prepare a homogeneous 50 mass % aqueous polymer solution.

After 200 g of the polymer solution, 100 g of C.I. Pigment Blue 15:3, and 700 g of ion-exchanged water were mixed and mechanically stirred for a predetermined period of time, the mixture was centrifuged to remove an undispersed material including coarse particles to prepare a cyan dispersion liquid. The obtained cyan dispersion liquid had a pigment concentration of 10 mass %.

### (2) Preparation of Ink

Ink was prepared by using the cyan dispersion liquid. The following components were added to the cyan dispersion liquid to obtain a desired concentration. The components were sufficiently mixed and stirred, and then filtered under pressure by a microfilter with a pore size of 2.5 μm (manufactured by Fuji Photo Film Co., Ltd.) to prepare a pigment ink having a pigment concentration of 2 mass %.

Cyan dispersion liquid: 20 parts

Glycerin: 10 parts

Diethylene glycol: 10 parts

Acetylene glycol EO adduct (manufactured by Kawaken Fine Chemicals Co., Ltd.): 0.5 parts

Ion-exchanged water: 59.5 parts

### Magenta Ink

### (1) Preparation of Dispersion Liquid

First, an AB block polymer having an acid value of 300 and a number-average molecular weight of 2500 was prepared using benzyl acrylate and methacrylic acid as raw materials in accordance with a usual method. The AB block polymer was then neutralized with an aqueous solution of potassium hydroxide, and was diluted with ion-exchanged water to prepare a homogeneous 50 mass % aqueous polymer solution.

After 100 g of the polymer solution, 100 g of C.I. Pigment Red 122, and 800 g of ion-exchanged water were mixed and mechanically stirred for a predetermined period of time, the mixture was centrifuged to remove an undispersed material including coarse particles to prepare a magenta dispersion liquid. The obtained magenta dispersion liquid had a pigment concentration of 10 mass %.

### (2) Preparation of Ink

Ink was prepared by using the magenta dispersion liquid. The following components were added to the magenta dispersion liquid to obtain a desired concentration. The components were sufficiently mixed and stirred, and then filtered under pressure by a microfilter with a pore size of 2.5 μm (manufactured by Fuji Photo Film Co., Ltd.) to prepare a pigment ink having a pigment concentration of 4 mass %.

Magenta dispersion liquid: 40 parts

Glycerin: 10 parts

Diethylene glycol: 10 parts

Acetylene glycol EC) adduct (manufactured by Kawaken Fine Chemicals Co., Ltd.): 0.5 parts

Ion-exchanged water: 39.5 parts

### Yellow Ink

### (1) Preparation of Dispersion Liquid

First, anionic polymer P-1 [styrene/butyl acrylate/acrylic acid copolymer (polymerization ratio (weight ratio)=30/40/30) having an acid value of 202 and a weight-average molecular weight of 6500 was neutralized with an aqueous solution of potassium hydroxide, and was diluted with ion-exchanged water to prepare a homogeneous 10 mass % aqueous polymer solution.

After 300 g of the polymer solution, 100 g of C.I. Pigment Yellow 74, and 600 g of ion-exchanged water were mixed and mechanically stirred for a predetermined period of time, the mixture was centrifuged to remove an undispersed material including coarse particles to prepare a yellow dispersion liquid. The obtained yellow dispersion liquid had a pigment concentration of 10 mass %.

### (2) Preparation of Ink

The following components were mixed and sufficiently stirred, and the mixture was dissolved and dispersed. The dispersed particles were filtered under pressure by a microfilter with a pore size of 1.0 μm (manufactured by Fuji Photo Film Co., Ltd.) to prepare a pigment ink having a pigment concentration of 4 mass %.

Yellow dispersion liquid: 40 parts

Glycerin: 9 parts

Ethylene glycol: 10 parts

Acetylene glycol EC) adduct (manufactured by Kawaken Fine Chemicals Co., Ltd.): 1 part

Ion-exchanged water: 40 parts

### Processing Liquid

### (1) Preparation of Processing Liquid

The following components were mixed, and sufficiently stirred to prepare a processing liquid.

As a slipping property imparting compound, commercially available acrylic silicone copolymer (trade name: SYMAC® US-450, manufactured by Toagosei Co., Ltd.): 5 parts

Glycerin: 5 parts

Ethylene glycol: 15 parts

Acetylene glycol EO adduct (manufactured by Kawaken Fine Chemicals Co., Ltd): 0.5 parts

Ion-exchanged water: 74.5 parts

The processing liquid according to this embodiment contains a transparent resin material to increase the scratch resistance of a recorded image and reduce bronzing. Examples of the transparent resin material include a transparent resin material copolymerized with a polydimethylsiloxane component. Using such a transparent resin material allows slipping even if external forces are applied to an ink image by a nail or the like, and the coefficient of dynamic friction can be efficiently reduced. In this embodiment, a commercially available transparent resin material copolymerized with a polydimethylsiloxane component (the above-described acrylic silicone copolymer: SYMAC® US-450) is used. This processing liquid may also be referred to as coating ink, surface coating ink, clear ink, reaction liquid, or improvement liquid.

A transparent layer is formed on the outermost surface of the pigment ink layers. In this embodiment, any resin material capable of improving image durability, namely, scratch resistance, and improving image quality, namely, anti-bronzing properties, may be used.

### Method for Reducing Bronzing

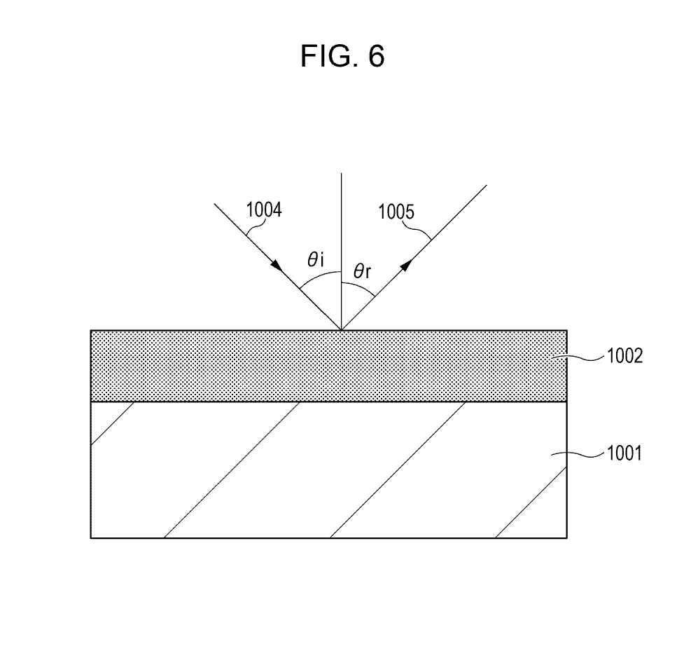

A method for reducing bronzing will be described with reference to FIG. 6.

FIG. 6 is a diagram illustrating an example cross section of a recording medium on which an ink layer is formed. The ink layer is formed by ejecting a pigment ink onto the recording medium and making the pigment ink adhere to the surface of the recording medium.

Reference numeral 1001 denotes a recording medium, and reference numeral 1002 denotes an ink layer. Reference numeral 1004 denotes a direction in which light enters (“incident direction”), and reference numeral 1005 denotes a direction in which light is reflected and emitted (“outgoing direction”). The light represented by reference numeral 1004 is hereinafter referred to as incident light, and the light represented by reference numeral 1005 is hereinafter referred to as reflected light.

Bronzing is a phenomenon where incident light acquires a color different from the color of the light when specularly reflected. In specular reflection, according to the law of reflection, light striking a surface of the ink layer 1002 at a given angle is reflected off at the same angle (θi=θr).

To measure bronzing, first, the surface of the ink layer 1002 is irradiated with light at a given angle on the incident direction 1004 side using a white light source, and the reflected light 1005 that has been specularly reflected is detected using a photoreceiver. The detected tristimulus values XxYxZx defined in the CIE XYZ color system may be converted into CIE L*a*b* values, and parameters derived from the L*a*b* values, such as hue and saturation C*, may be obtained as values indicating a magnitude of bronzing. Since bronzing is related to the tint (tint value) of light visible in an image, rather than brightness, in this embodiment, the L* value, which is a value indicating brightness, is not used for evaluation.

As a light source, for example, a halogen lamp, a xenon lamp, an ultra-high pressure mercury lamp, a deuterium lamp, a light emitting diode (LED), or a combination of some of them may be used. As a photoreceiver, for example, a single-photoreceiving-surface photodiode, a photocell, a photomultiplier, a multielement-photoreceiving-surface Si photodiode array, a charge-coupled device (CCD) sensor, or the like may be used. Each of the light source and the photoreceiver may have an optical (such as a lens) system. In this embodiment, chromaticity is measured using Spectroradiometer CS-2000A manufactured by Konica Minolta Sensing Americas, Inc., to measure bronzing. Any measurement device capable of measuring bronzing of pigment ink may be used.

Any type of recording medium may be used as long as the recording medium is capable of measuring the magnitude of bronzing of dry ink. For example, a desired sheet-shaped medium such as an overhead projector (OHP) sheet may be used. In addition, a recording operation may not necessarily be performed by a recording apparatus, and it may only be required that a layer of ink be formed on a surface of a sheet-shaped medium.

Table 1 shows measurement values concerning bronzing, which were determined from a recording medium on which recording was performed using cyan ink, magenta ink, and yellow ink.

The magnitude of bronzing is expressed as saturation (C*). The measurement results given in Table 1 were obtained through the ejection of pigment inks onto a recording medium at 100% duty and through multi-path recording with eight scans in total. In this embodiment, ejection of one dot of ink onto a region with sides of 1/1200 inch (hereinafter referred to as “1200-dpi sides”) of a recording medium is defined as ejection at 100% duty. In measurement given in Table 1, glossy photo paper manufactured by CANON KABUSHIKI KAISHA (trade name: “Glossy Photo Paper [thin] LFM-GP421R” was used as the recording medium.

TABLE 1
Bronzing of inks

| Type of ink | Bronzing value (C*) | Bronzing color |
|---|---|---|
| Cyan ink | 35 | Red |
| Magenta ink | 30 | Red |
| Yellow ink | 4 | Blue |

As given in Table 1, bronzing may appear as reflected light of a different color, rather than white of the light source or the ink's own color, to the human eye. In addition, the intensity of bronzing can be measured using the bronzing value (C*).

Referring to Table 1, cyan ink and magenta ink exhibit larger bronzing values than yellow ink. Further, cyan ink and yellow ink have bronzing of colors different from the colors of the inks. Among the inks given here, cyan ink exhibits red bronzing, and also has a large bronzing value, resulting in the lowest perceptual quality to the human eye.

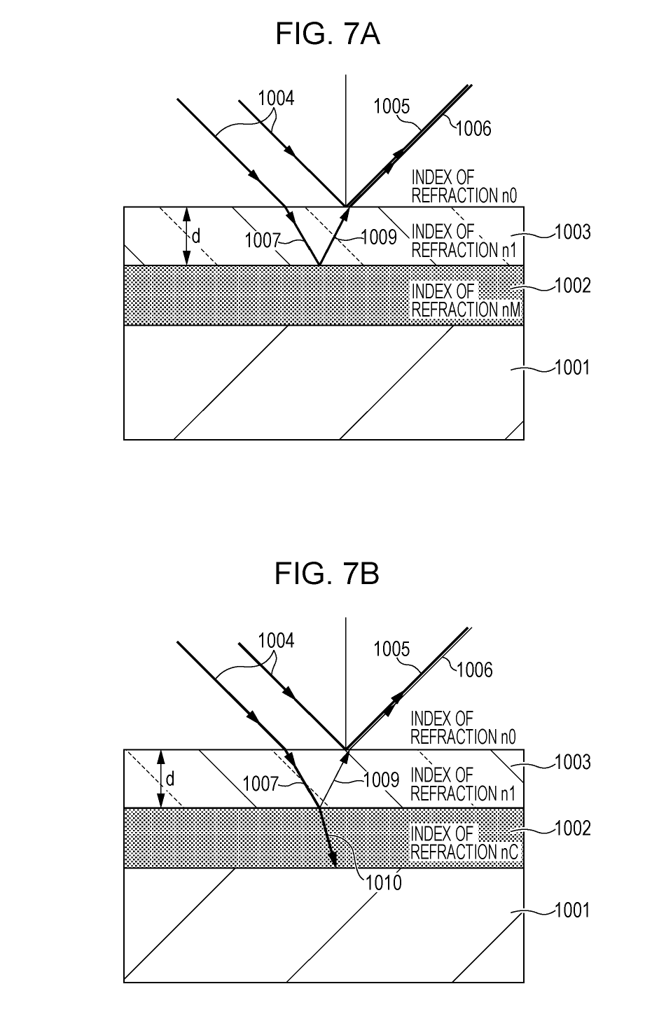

FIGS. 7A and 7B are diagrams each illustrating an example cross section of a recording medium on which a transparent layer formed of a processing liquid is formed on an ink layer formed by a pigment ink.

Reference numeral 1001 denotes a recording medium, reference numeral 1002 denotes an ink layer, and reference numeral 1003 denotes a transparent layer. Incident light 1004 is separated into light (surface-reflected light) 1005 specularly reflected from the surface of the transparent layer 1003 and light 1007 that travels through the transparent layer 1003 after the angle of the travel direction is changed at the surface of the transparent layer 1003. The light 1007 transmitted through the transparent layer is separated into light 1009 specularly reflected from the surface of the ink layer 1002 and light 1010 that travels through the ink layer 1002 after the angle of the travel direction is changed at the surface of the ink layer 1002.

Here, the extent to which light traveling straight changes its angle of the travel direction at the boundary between two different media such as the air and the transparent layer 1003 or the transparent layer 1003 and the ink layer 1002 (also called the phase speed ratio) is referred to as the index of refraction.

When light enters a first medium from a second medium having an index of refraction different from the first medium, a phenomenon called reflection of light always occurs on the interface between the first and second media. For example, when light enters a medium having an index of refraction n1 from the air layer (having an index of refraction n0), reflection having an intensity given by the following formula occurs:

R=(n1−n0)̂2/(n1+n0)̂2 (formula 1)

R: reflectance
n0: index of refraction for air layer
n1: index of refraction for medium
Formula 1 is given from Fresnel's equations, for vertical incidence.

In this embodiment, to reduce bronzing, the transparent layer 1003 is formed on the surface of the ink layer 1002, and the reflected light 1005 from the surface of the formed transparent layer 1003 and reflected light 1006 from the interface between the transparent layer 1003 and the ink layer 1002 are made to interfere with each other.

The intensity of the surface-reflected light 1005 depends on the index of refraction (n1) for the transparent layer 1003, and the intensity of interface-reflected light 1009 depends on the difference between the index of refraction (n) for the ink layer 1002 and the index of refraction (n1) for the transparent layer 1003.

Because of a large difference in index of refraction between the ink layer 1002 and the transparent layer 1003, the majority of the light incident on the interface is reflected off the interface. Thus, interference between the interface-reflected light 1009 and the surface-reflected light 1005 is likely to occur. Conversely, if the difference in index of refraction between the ink layer 1002 and the transparent layer 1003 is small, the amount of interface-reflected light 1009 is reduced, and interference is less likely to occur. Therefore, in order to reduce bronzing using the technique described above, the difference in index of refraction between the transparent layer 1003 and the ink layer 1002 needs to be increased.

The index of refraction may be measured using, for example, a spectroscopic ellipsometer or the like. A spectroscopic ellipsometer measures the polarization change caused by interference between reflected light of laser light from a front surface of a thin film after the sample is irradiated with the laser light and light reflected from a rear surface of the film, and thereby measures the thickness and index of refraction for the film. Note that any type of measurement device capable of measuring the index of refraction may be used.

Then, a description will be made of the index of refraction measured from each of the transparent layer 1003 and the spectroscopic ink layer 1002. The indices of refraction were obtained by ejecting a pigment ink onto glossy photo paper manufactured by CANON KABUSHIKI KAISHA (trade name: “Glossy Photo Paper [thin] LFM-GP1R” at 100% duty and by measuring the resulting image using the spectroscopic ellipsometer described above.

The transparent layer 1003 (processing liquid) had an index of refraction of approximately 1.4. The ink layer 1002 (pigment ink) had an index of refraction of approximately 1.3 to 1.8, and had wavelength dispersion characteristics. For example, the index of refraction for black ink was approximately 1.5 to 1.6, the index of refraction for magenta ink was approximately 1.5 to 1.7, the index of refraction for cyan ink was approximately 1.3 to 1.6, and the index of refraction for yellow ink was approximately 1.75 to 2.2.

On the basis of the above-described results, in the following description, pigment inks having a difference in index of refraction from that of the processing liquid are magenta ink and yellow ink, and pigment inks having a small difference in index of refraction from that of the processing liquid are cyan ink and black ink. The determination as to whether the difference in index of refraction between each ink and the processing liquid is large or not may be based on, for example, a threshold value (predetermined standard). For example, it is assumed that, based on the measurement values described above, the index of refraction for black ink is 1.6 (maximum value), the index of refraction for magenta ink is 1.7 (maximum value), the index of refraction for cyan ink is 1.6 (maximum value), and the index of refraction for yellow ink is 2.2 (maximum value). In this case, if the difference between the index of refraction for ink and the index of refraction (1.4) for the processing liquid is greater than or equal to a predetermined standard (for example, 0.3), it is determined that the ink has a large difference in index of refraction from the processing liquid. Using such a rule, inks having large and small differences in index of refraction from the processing liquid can be classified in the manner described above.

Next, interference of reflected light which is caused by the difference in index of refraction will be described. First, interference of reflected light (on a thin film) is a phenomenon where the light reflected on a front surface of the transparent layer 1003 and the light transmitted through the front surface of the transparent layer 1003 and reflected on a rear surface of the transparent layer 1003 interfere with each other and reinforce or cancel each other to produce an interference color.

The thickness of the transparent layer 1003 formed by the processing liquid is generally approximately 100 nm to 500 nm. In the transparent layer (transparent thin film layer) 1003, an interference color is likely to occur. An optical path difference occurs between the light 1007 transmitted through the transparent layer 1003 and the incident light 1004, and the light beams reinforce or cancel each other in accordance with a relationship between the distance of the optical path difference and the wavelengths of the light beams.

In this case, generally, the following formula holds true:

m*λ=n1*2d*cos θ+λ/2 (formula 2)

m: integer
n1: index of refraction for transparent layer
d: thickness of transparent layer
θ: angle of incidence
The light beams having the wavelength λ satisfying the above condition reinforce each other to produce a bright color.

Table 2 shows measurement values regarding interference colors. The measurement values were obtained by sequentially applying the cyan ink and the processing liquid (so that the processing liquid have a substantially uniform thickness) to the recording medium and then performing measurement on the recording medium using a measurement device. Glossy photo paper manufactured by CANON KABUSHIKI KAISHA (trade name: “Glossy Photo Paper [thin] LFM-GP421R” was used as the recording medium. Spectroradiometer CS-2000A manufactured by Konica Minolta Sensing Americas, Inc., was used as a measurement device for measuring interference colors. That is, chromaticity was measured using this measurement device. Any type of measurement device capable of measuring an interference color may be used.

The cyan ink was ejected at 100% duty, and the ejection duty for the processing liquid was switched stepwise.

TABLE 2
Amount of applied processing liquid and interference color

| Amount of applied processing | |
|---|---|
| liquid | Interference color |
| 10% | None |
| 25% | Blue |
| 50% | Green |
| 70% | Yellow |
| 90% | Red-yellow |
| 110% | Red |

As given in Table 2, if the amount of applied processing liquid is small, no interference colors occur because the wavelength region satisfying formula 2 is not included in the visible light region. In contrast, as the amount of applied processing liquid increases (the thickness increases), the wavelength giving an interference color increases. That is, an interference color changes in accordance with the thickness d of the transparent layer 1003.

The reflected light out of light incident on the ink layer 1002 and the transparent layer 1003 in the manner described above acquires a color tint. For example, light of a fluorescent lamp or the like that is visible in an image is not reflected as a natural white color but generates an interference color.

The following features are designed to reduce bronzing using the method according to this embodiment.

(a) Making the thickness d of the transparent layer 1003 vary.
(b) Causing light to be brightly reflected from the interface between the transparent layer (first layer) 1003 and the ink layer (second layer) 1002 adjoining the transparent layer (first layer) 1003 to cause thin-film interference.

The variation in the thickness d of the transparent layer 1003 in item (a) given above will now be described. The variation in the thickness d of the transparent layer 1003 may be implemented by, for example, forming the surface of the transparent layer 1003 into irregularities, or may be implemented by forming the interface between the transparent layer 1003 and the ink layer 1002, that is, the surface of the ink layer 1002, into irregularities.

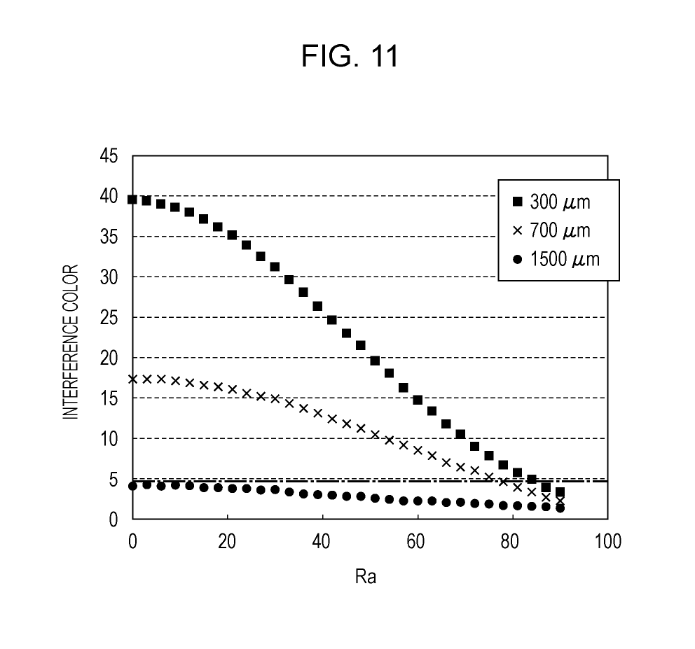

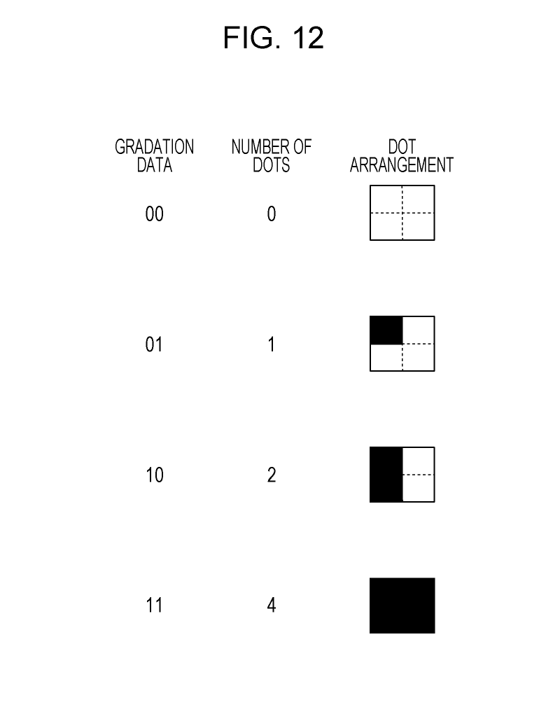

FIG. 11 illustrates the results of simulating what surface roughness (Ra) the surface of the ink layer would need to exhibit to make interference colors vary and cancel out each other. Specifically, how the intensity of the interference color (C*) changes when the surface roughness of the surface of the ink layer changes is illustrated in the form of graph.

Here, the lower the intensity of the interference color is, the more the interference color becomes achromatic as an entire image. In general, an interference color having an intensity of approximately 5 or less is visually negligible. If the thickness of the transparent layer 1003 is 300 μm, 700 μm, and 1500 μm, it is found that the intensity of the interference color becomes approximately 5 or less with respect to a surface roughness (Ra) of approximately 80 nm or more. According to the simulation results illustrated in FIG. 11, if the surface roughness (Ra) of black ink is set to, for example, 90 nm, the intensity of the interference color becomes approximately 5 or less. More specifically, the surface roughness (Ra) of black ink may be in a range of approximately 80 nm or more and approximately 100 nm for single-color recording.

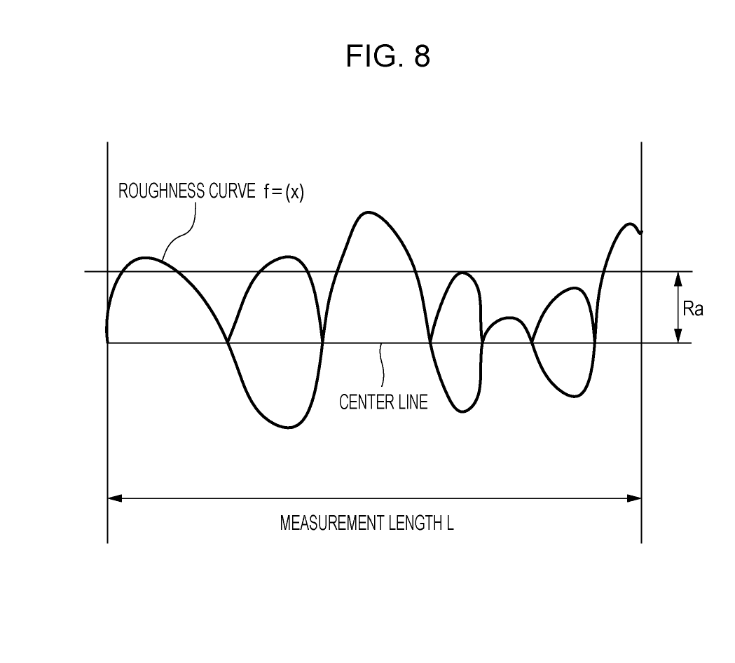

The surface roughness (Ra) is called the center-line average roughness, and, as illustrated in FIG. 8, the value obtained by folding the roughness curve at the center line and dividing the area defined by the roughness curve and the center line by a length L is expressed in micrometers (μm). In this embodiment, the surface roughness was measured using Nanoscale Hybrid Microscope manufactured by Keyence Corporation. Any measurement device capable of measuring the surface roughness of the ink layer may be used.

A variety of methods for increasing the roughness of the surface of the transparent layer 1003 and the ink layer 1002 are conceivable, and any of them may be used. For example, the type or prescription of pigment ink, the recording conditions of pigment ink, the recording conditions of processing liquid, and the like may be changed.

The thin-film interference in item (b) given above is produced by increasing the difference in index of refraction between the transparent layer 1003 and the ink layer 1002 adjoining the transparent layer 1003. The effectiveness when the order in which the pigment inks of the respective colors are to be applied to the recording medium is optimized using the difference in index of refraction will now be described. Among the pigment inks, magenta ink having a large difference in optical characteristics (in this embodiment, the index of refraction) from the transparent layer and cyan ink having a small difference will be described here as an example.

In FIG. 7A, an ink layer 1002 is formed by magenta ink, and a transparent layer 1003 is formed on the ink layer 1002. In FIG. 7B, an ink layer 1002 is formed by cyan ink, and a transparent layer 1003 is formed on the ink layer 1002.

In FIG. 7A, the ink layer 1002 (magenta ink), which has a large difference in index of refraction from the transparent layer 1003 is placed immediately below the transparent layer 1003. In this case, incident light 1004 is separated into light 1005 that is reflected from the surface of the transparent layer 1003 and light 1007 that travels through the transparent layer 1003. Because of the large difference between the index of refraction n1 of the transparent layer 1003 and the index of refraction nM of the ink layer (magenta ink) 1002, the majority of the light 1007 becomes reflected light 1009. The stacking structure described above allows strong reflected light to be obtained from the interface. Thus, the light 1005 and light 1006 interfere with each other on the surface of the transparent layer 1003, yielding interference colors having different wavelengths in accordance with the thickness d of the transparent layer 1003. Therefore, a bronzing color of the ink layer (magenta ink) 1002 can be canceled out, and the light appears white to the human eye, resulting in an image being perceived to be of good quality.

In FIG. 7B, in contrast, the ink layer 1002 (cyan ink) having a small difference in index of refraction from the transparent layer 1003 is placed immediately below the transparent layer 1003. In this case, incident light 1004 is separated into light 1005 that is reflected from the surface of the transparent layer 1003 and light 1007 that travels through the transparent layer 1003. Because of the small difference between the index of refraction n1 of the transparent layer 1003 and the index of refraction nC of the ink layer (cyan ink) 1002, the light 1007 is further separated into reflected light 1009 and light 1010 that travels through the pigment ink. Thus, the reflected light 1009 is weakened on the interface between the transparent layer 1003 and the ink layer 1002, and interference between the light 1005 and light 1006 is less likely to occur on the surface of the transparent layer 1003. That is, if the difference in index of refraction between the transparent layer 1003 and the ink layer 1002 is small, the incident light 1004 is weakly reflected on the interface between the transparent layer 1003 and the ink layer 1002, and travels through the ink layer 1002. Therefore, interference is less likely to occur on the surface of the transparent layer 1003, and bronzing of pigment ink (cyan ink) is seen, and an image is perceived to be of low quality.

Accordingly, this embodiment focuses on the easiness of occurrence of interference based on the difference in index of refraction between the transparent layer 1003 and the ink layer 1002, and is intended to reduce a bronzing color in an image recorded with pigment inks. Specifically, since interference is likely to occur when the difference in index of refraction between the transparent layer 1003 and the ink layer 1002 is large, a pigment ink is applied to the recording medium so that an ink layer having a large difference in index of refraction from the transparent layer 1003 adjoins the transparent layer 1003.

### Example Configuration of Image Processing System

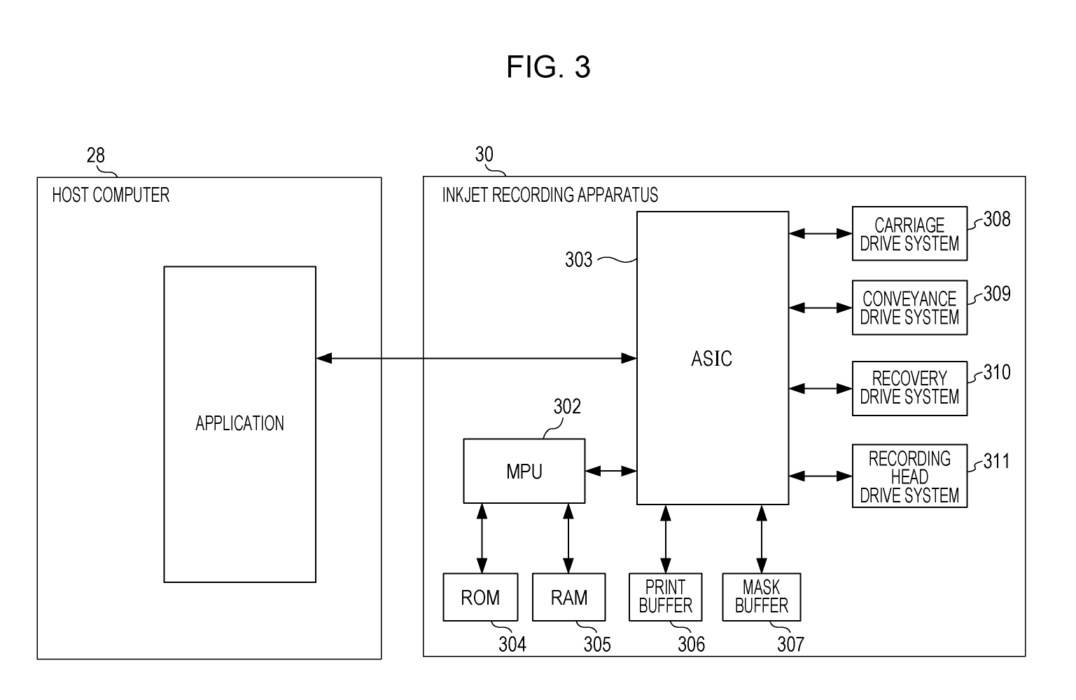

FIG. 3 is a block diagram illustrating a configuration of a control system in an inkjet recording apparatus according to an exemplary embodiment of the present invention. A description will be given here of a section for generating ejection data. A host computer (image input unit) 28 transmits RGB multivalued image data stored in a storage medium such as a hard disk to an image processing unit. The multivalued image data may also be received from an image input device connected to the host computer 28, such as a scanner or a digital camera. The image processing unit performs image processing, described below, on the input multivalued image data to convert the multivalued image into binary image data. Accordingly, binary image data (ejection data for ink) for ejecting a plurality of types of pigment inks from recording heads is generated. The image processing unit also generates binary image data (ejection data for processing liquid) for ejecting a processing liquid. An inkjet recording apparatus (image output unit) 30 applies pigment inks to a recording medium for each scan of the recording heads 22 in accordance with binary image data of at least two or more types of pigment inks, which has been generated by the image processing unit, to record an image on the recording medium. The image output unit 30 is controlled by a micro processor unit (MPU) 302 in accordance with a program recorded on a read-only memory (ROM) 304. A random access memory (RAM) 305 is used as a work area of the MPU 302 or a temporary data storage area. The MPU 302 controls a carriage drive system 308, a conveyance drive system 309 for a recording medium, a recovery drive system 310 for the recording heads, and a recording head drive system 311 via an application specific integrated circuit (ASIC) 303. Further, the MPU 302 is configured to be capable of reading and writing data from and to a print buffer 306 from which and to which data is readable and writable through the ASIC 303.

The print buffer 306 temporarily holds image data that has been converted into a format that can be transferred to a head. A mask buffer 307 temporarily holds a predetermined mask pattern for the data transferred from the print buffer 306, which is to be subjected to AND processing, if necessary, when transferring the mask pattern to the head. A plurality of sets of mask patterns for multi-path recording, which allow the ink application order, described below, to be changed, are prepared in the ROM 304. A desired mask pattern is read from the ROM 304 during actual recording, and is stored in the mask buffer 307.

### Image Processing

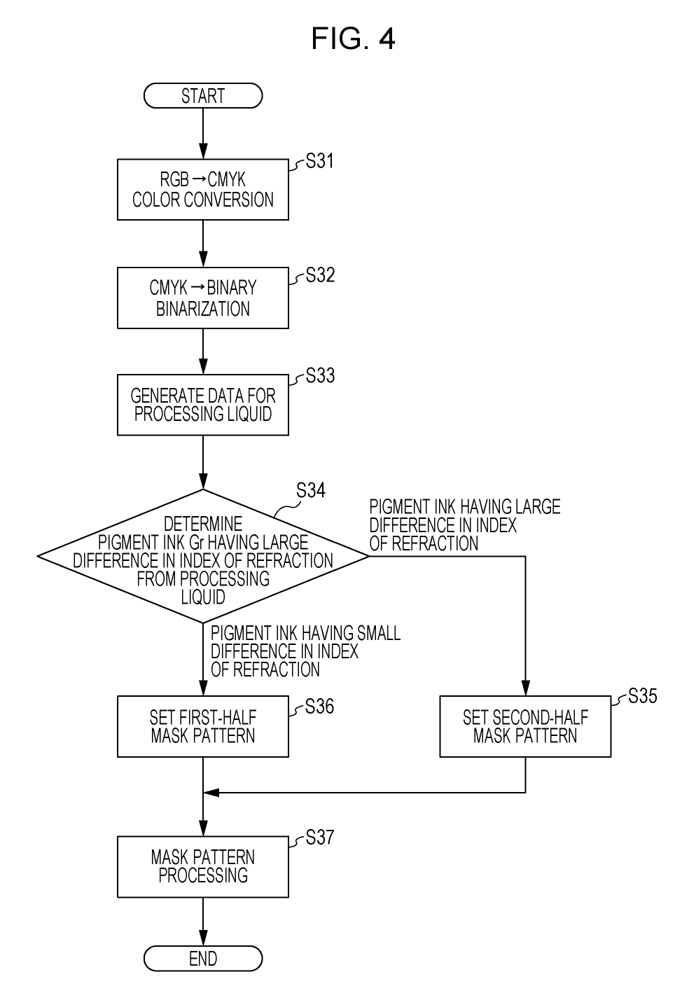

A method for generating ejection data for the processing liquid and pigment ink according to this embodiment will be described with reference to FIG. 4. FIG. 4 is a flowchart of the image processing unit described above, and the image processing unit generates ejection data for the pigment ink and ejection data for the processing liquid.

Specifically, first, RGB multivalued image data is input from the host computer (image input unit) 28. The RGB multivalued image data is subjected to color conversion in step S31, and is converted into multivalued image data respectively corresponding to a plurality of types of inks (K, C, M, Y) to be used for image formation. Then, in binarization processing in step S32, the multivalued image data corresponding to the respective inks is expanded into binary image data for the corresponding inks in accordance with a stored pattern. Thus, binary image data for respectively applying a plurality of types of pigment inks is generated.

In step S33, the generated binary image data of the plurality of types of pigment inks (K, C, M, Y) is subjected to AND processing to generate binary image data of the processing liquid. The binary image data for the processing liquid may not necessarily be based on the binary image data of the plurality of types of pigment inks but may be generated so as to have a pattern in which the processing liquid uniformly covers the entirety of the recording medium. The binary image data for the processing liquid may be generated using any method. In this embodiment, a treatment-liquid pattern in which the processing liquid was applied at approximately 100% duty regardless of the presence of dots of pigment ink is used.

In step S34, it is determined whether the binary image data is binary image data of a pigment ink Gr having a large difference in index of refraction from the processing liquid or binary image data of a pigment ink Gr having a small difference in index of refraction from the processing liquid. As described above, the index of refraction for each of the processing liquid and the pigment inks is measured in advance, and the ink type of the pigment ink Gr having a large difference in index of refraction from the processing liquid and the ink type of the pigment ink Gr having a small difference in index of refraction from the processing liquid are also stored in advance in the ROM 304. For the pigment ink Gr having a large difference in index of refraction from the processing liquid, in step S35, a second-half mask pattern, described below, is used to set the amount of ink to be applied. For the pigment ink Gr having a small difference in index of refraction from the processing liquid, in step S36, a first-half mask pattern, described below, is used to set the amount of ink to be applied.

Then, in step S37, the binary image data of the plurality of types of pigment inks is subjected to processing using the set mask pattern to generate ejection data in the format that can be transferred to the recording heads.

For example, it is assumed that an image in a predetermined region that has been subjected to binarization processing in step S32 is constituted by magenta ink, which is a pigment ink Gr having a large difference in index of refraction from the processing liquid, and cyan ink, which is a pigment ink Gr having a small difference in index of refraction from the processing liquid. In this case, for the magenta ink, which is determined in step S34 to be a pigment ink Gr having a large difference in index of refraction from the processing liquid, the second-half mask pattern is set, and, in step S37, ejection data is generated. In contrast, for the cyan ink, which is determined in step S34 to be a pigment ink Gr having a small difference in index of refraction from the processing liquid, the first-half mask pattern is set, and, in step S37, ejection data is generated.

In accordance with the ejection data generated in the manner described above, pigment inks are ejected from the recording heads of the inkjet recording apparatus (image output unit) 30 using a multi-path recording method described below to generate an image.

### Recording Operation

A recording operation of a recording apparatus having the configuration described above for performing characteristic control described above according to this embodiment will be described. The term “characteristic control” means the control of the ink application order so that a pigment ink having a large difference in index of refraction from the transparent layer adjoins the transparent layer. In this embodiment, a multi-path recording method is employed in which an image is formed with pigment inks for each predetermined region through eight scans in total. The processing liquid for covering a surface of a pigment ink image is applied through four consecutive scans after the completion of the formation of an image formed of pigment inks. The processing liquid recording method may involve a single scan, and the number of scans and the application method are not limited.

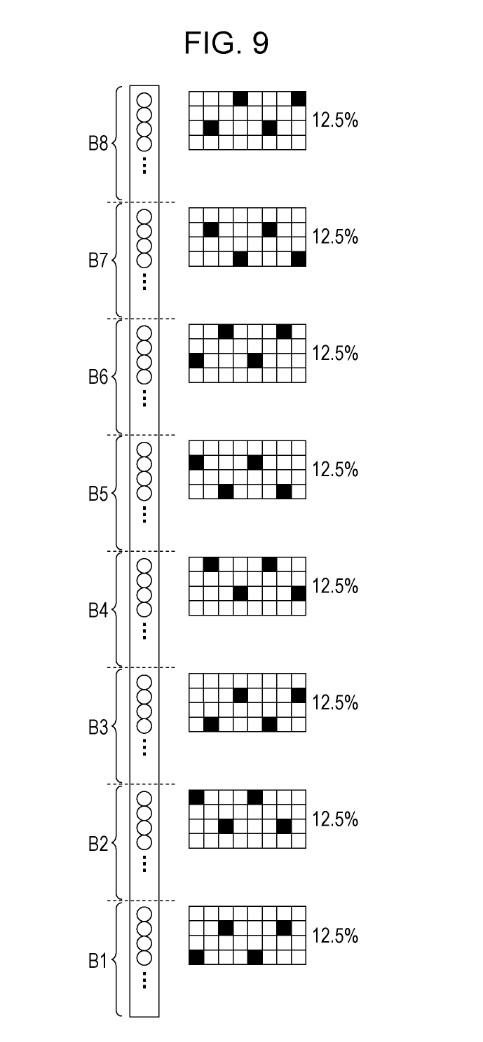

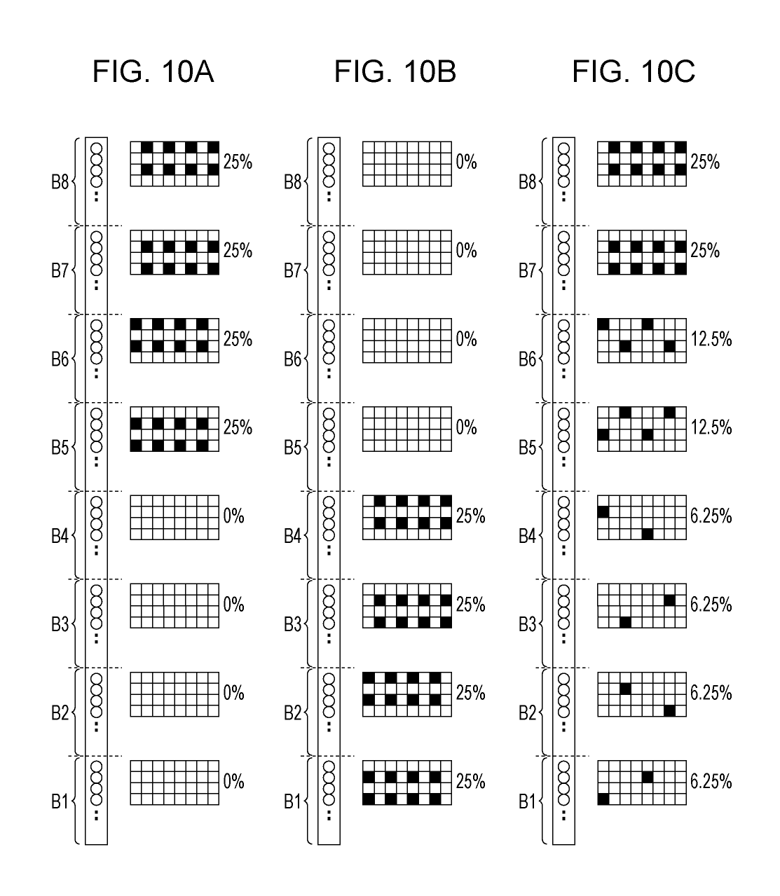

During eight scans in total to form an image of pigment inks, in the related art, a mask pattern for distributing ink over the entirely of a region of a row of ejection ports, such as a mask pattern illustrated in FIG. 9 for equally distributing ink during each scan, is used. In contrast, in this embodiment, processing is performed as follows: In step S34 in FIG. 4, it is determined whether binary image data of each of a plurality of types of pigment inks is binary image data of a pigment ink Gr having a large difference in index of refraction from the processing liquid or binary image data of a pigment ink having a small difference in index of refraction from the processing liquid. The second-half mask pattern is set for binary image data of ink determined to be binary image data of a pigment ink Gr having a large difference. Then, in step S37, ejection data is generated. FIG. 10A illustrates a second-half mask pattern. In the illustrated mask pattern, ink is not ejected during the first four scans among eight scans in total. That is, the illustrated mask pattern is a mask pattern for ejecting ink over all the pixels during the last four scans including the last scan. In contrast, the first-half mask pattern is set for binary image data of ink determined to be binary image data of a pigment ink Gr having a small difference in index of refraction from the processing liquid. Then, in step S37, ejection data is generated. FIG. 10B illustrates a first-half mask pattern. In the illustrated mask pattern, ink is ejected only through the first four scans among eight scans in total. That is, the illustrated mask pattern is a mask pattern for ejecting ink over all the pixels during the first four scans including the first scan.

The example described above is used for, for example, magenta ink, which is a pigment ink Gr having a large difference in index of refraction from the transparent layer, and cyan ink, which is a pigment ink Gr having a small difference in index of refraction from the transparent layer. The second-half mask pattern is used for binary image data of magenta ink, which is determined in step S34 to be a pigment ink Gr having a large difference. In contrast, the first-half mask pattern is used for binary image data of cyan ink, which is determined to be a pigment ink Gr having a small difference. Accordingly, because of the nature of light, reflected light on the interface between the transparent layer and the pigment ink layer is stronger when magenta ink having a large difference in index of refraction from the transparent layer adjoins the transparent layer than when cyan ink having a small difference in index of refraction from the transparent layer adjoins the transparent layer. As a consequence, interference can occur on the surface of the transparent layer, thereby achieving the effect of reducing a bronzing color due to pigment ink. During four scans in total to form an image for the processing liquid, a mask pattern (not illustrated) for equally distributing the processing liquid at 25% duty is used. The mask pattern to be used for the processing liquid is not limited. The following description will be given along with the above-described example.

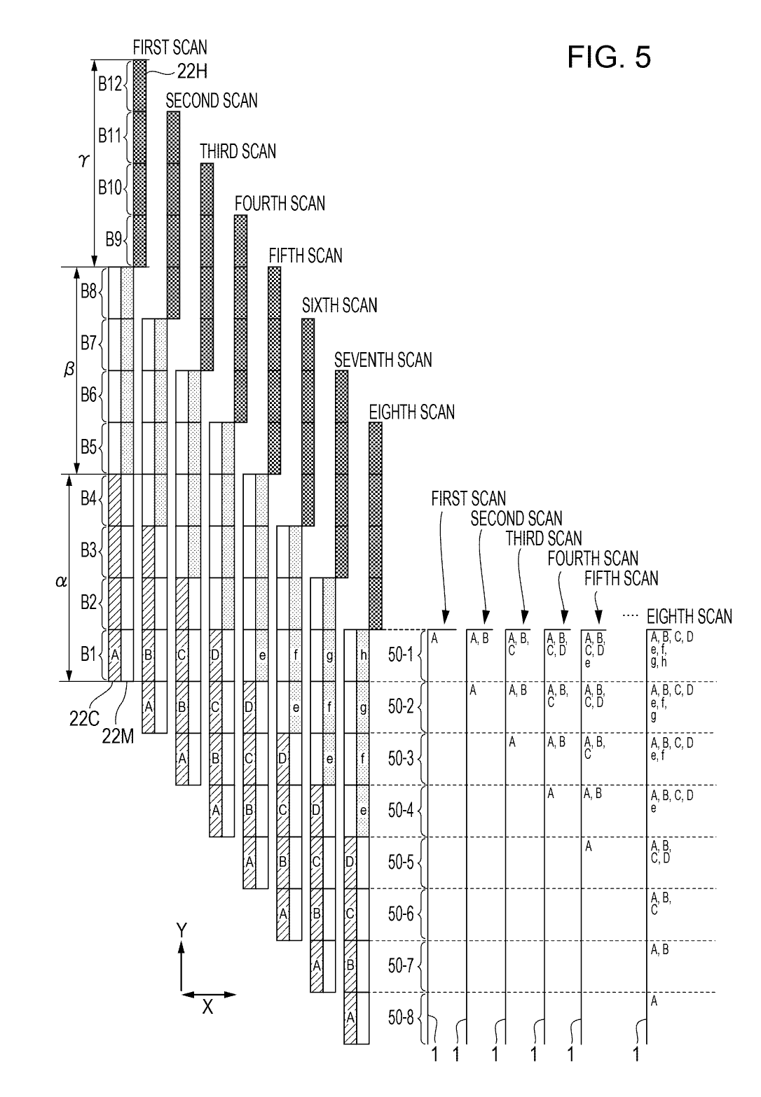

FIG. 5 is an explanatory diagram of a method for recording an image area formed with magenta ink, which is ejected using the second-half mask pattern in the example described above, and with cyan ink, which is ejected using the first-half mask pattern. The recording head 22C for ejecting cyan (C) ink and the recording head 22M for ejecting magenta (M) ink have each 1280 ejection ports which are equally divided into eight blocks B1, B2, B3, B4, B5, B6, B7, and B8 each having 160 ejection ports. In the recording head 22C, 640 ejection ports in a range α of blocks B1 to B4 (see FIG. 2A) are used, and the ejection ports in the blocks B1 to B4 are hereinafter referred to also as ejection ports in regions A, B, C, and D. In the recording head 22M, 640 ejection ports in a range β of blocks B5 to B8 (see FIG. 2A) are used, and the ejection ports in the blocks B5 to B8 are hereinafter referred to also as ejection ports in regions e, f, g, and h. In the recording head 22H for ejecting the processing liquid, the 640 ejection ports are divided into four blocks B9, B10, B11, and B12 each having 160 ejection ports. In the recording head 22H, the 640 ejection ports in a range γ of blocks B9 to B12 (see FIG. 2A) are used. In FIG. 5, the recording medium 1 has recording areas 50-1, 50-2, 50-3, 50-4, 50-5, 50-6, 50-7, and 50-8, each corresponding to one block of a recording head.

First, in the first scan, ink is ejected from the ejection ports in the region A of the recording head 22C in accordance with the ejection data for the first scan of the recording area 50-1.

Then, the recording medium 1 is conveyed in the sub-scanning direction (direction indicated by the arrow Y) by an amount corresponding to the length of the 160 ejection ports of the recording head. In FIG. 5, the recording heads relatively move in the direction (direction indicated by the arrow X) crossing the sub-scanning direction. Then, in the second scan, ink is ejected from the ejection ports in the region B of the recording head 22C in accordance with the ejection data for the second scan of the recording area 50-1. During the second scan, the first scan is performed on the recording area 50-2.

The third scan and the fourth scan are performed in a manner similar to that described above.

Through the first to fourth scans, the image in the recording area 50-1 is recorded with cyan (C) ink.

Next, the recording medium 1 is conveyed in the sub-scanning direction by an amount corresponding to the length of the 160 ejection ports of the recording head. After that, during the fifth scan, ink is ejected from the ejection ports in the region e of the recording head 22M in accordance with the ejection data for the fifth scan of the recording area 50-1. During the fifth scan, the fourth scan for the recording area 50-2, the third scan for the recording area 50-3, the second scan for the recording area 50-4, and the first scan for the recording area 50-5 are performed.

Next, the recording medium 1 is conveyed in the sub-scanning direction by an amount corresponding to the length of the 160 ejection ports of the recording head. After that, during the sixth scan, ink is ejected from the ejection ports in the region f of the recording head 22M in accordance with the ejection data for the sixth scan of the recording area 50-1. During the sixth scan, the fifth scan for the recording area 50-2, the fourth scan for the recording area 50-3, the third scan for the recording area 50-4, the second scan for the recording area 50-5, and the first scan for the recording area 50-6 are performed.

The seventh scan and the eighth scan are performed in a manner similar to that described above.

Through the fifth to eighth scans, the image in the recording area 50-1 is recorded with magenta (M) ink.

Next, the recording medium 1 is conveyed in the sub-scanning direction by an amount corresponding to the length of the 160 ejection ports of the recording head. After that, during the ninth scan, the processing liquid is ejected from the ejection ports in the recording head 22H in accordance with the ejection data for the ninth scan of the recording area 50-1. During the ninth scan, the eighth scan for the recording area 50-2, the seventh scan for the recording area 50-3, the sixth scan for the recording area 50-4, the fifth scan for the recording area 50-5, the fourth scan for the recording area 50-6, the third scan for the recording area 50-7, the second scan for the recording area 50-8, and the first scan for the recording area 50-9 are performed.

Next, the recording medium 1 is conveyed in the sub-scanning direction by an amount corresponding to the length of the 160 ejection ports of the recording head. After that, during the tenth scan, the processing liquid is ejected from ejection ports in the recording head 22H in accordance with the ejection data for the ninth scan of the recording area 50-1. During the tenth scan, the ninth scan for the recording area 50-2, the eighth scan for the recording area 50-3, the seventh scan for the recording area 50-4, the sixth scan for the recording area 50-5, the fifth scan for the recording area 50-6, the fourth scan for the recording area 50-7, the third scan for the recording area 50-8, the second scan for the recording area 50-9, and the first scan for the recording area 50-10 are performed.

The eleventh scan and the twelfth scan are performed in a manner similar to that described above.

Through the ninth to twelfth scans, the image in the recording area 50-1 is coated with the processing liquid (H) ink.

Subsequently, scans similar to those described above are repeatedly performed to sequentially record images with pigment inks in the recording areas 50-2, 50-3, etc., and to sequentially coat the images with the processing liquid.

Accordingly, pigment inks having different indices of refraction can be applied using different recording methods in accordance with the difference in index of refraction between a transparent layer and each pigment ink. That is, the order in which pigment inks are to be applied can be controlled such that an ink, which is a pigment ink Gr having a large difference in index of refraction from the transparent layer, is applied during the second half scans so that the ink layer formed of the ink adjoins the transparent layer, and an ink, which is a pigment ink Gr having a small difference in index of refraction from the transparent layer, is applied during the first half scans so that the ink layer formed of the ink do not adjoin the transparent layer. Hence, reflected light becomes strong on the interface between the transparent layer and the pigment ink layer, thus causing interference to occur on the surface of the transparent layer. Therefore, a bronzing color of pigment ink can be reduced.

In this embodiment, an image is formed using magenta ink, which is a pigment ink Gr having a large difference in index of refraction from the transparent layer, during four scans including the last scan among eight scans in total for forming the image, and using cyan ink, which is a pigment ink Gr having a small difference in index of refraction from the transparent layer, during four scans including the first scan. However, in the present invention, the number of scans to apply a pigment ink is not limited, and the numbers of scans to apply respective pigment inks Gr may differ. For example, a first pigment ink Gr may be ejected during a smaller number of scans than ink may be smaller than a second pigment ink Gr.

Furthermore, in this embodiment, for cyan ink, which is a pigment ink Gr having a small difference in index of refraction from the transparent layer, the first-half mask pattern illustrated in FIG. 10B is used to form an image through four scans including the first scan. However, in the present invention, the ratio of a portion of an ink layer that is formed of a pigment ink having a large difference in index of refraction from the transparent layer and that adjoins the transparent layer to the entire ink layer may be increased. Thus, a mask pattern of the related art with an equal ratio, as illustrated in FIG. 9, or the like, may be used for an ink, which is a pigment ink Gr having a small difference.

In this embodiment, furthermore, for magenta ink, which is a pigment ink Gr having a large difference in index of refraction from the transparent layer, the second-half mask pattern illustrated in FIG. 10A is used to form an image through four scans including the last scan. However, in the present invention, the ratio of a portion of an ink layer that is formed of a pigment ink having a large difference in index of refraction from the transparent layer and that adjoins the transparent layer to the entire ink layer may be increased. Thus, an effect can be achieved if the ratio of ink applied during the second half scans to ink applied during a plurality of scans is high. In this case, a mask pattern illustrated in FIG. 10C in which the ratio of ink ejected during the second half scans to ink ejected during eight scans in total is high, may be used. If the total number of scans is an odd number such as seven, it may only be required that when the amount of ink to be applied during the median scan, i.e., the fourth scan, is divided into halves which are equally distributed to the amount of ink to be applied during the first half before the median, i.e., the first to third scans, and to the amount of ink to be applied during the second half after the median, i.e., the fifth to seventh scans, the ratio of the amount of ink to be applied during the second half scans to the amount of ink to be applied during all the scans be high.

Furthermore, a mask pattern is used as a method for distributing ejection data for pigment inks so that an ink, which is a pigment ink Gr having a large difference in index of refraction from the transparent layer, adjoins the transparent layer. However, any other distribution method may be used.

In this embodiment, furthermore, only the index of refraction is used to determine which ink to form the ink layer that adjoins the transparent layer. However, such an ink may be determined by taking into account other conditions such as the amount of ink to be applied, the density of an image, and the gradation of an image. In addition, the ratio of ink to be applied during the second half scans to the total ink to make the ink layer adjoin the transparent layer, the number of scans, and the like may also differ depending on the above-described conditions or the like.

In this embodiment, furthermore, ink is separated into pigment inks Gr (magenta ink, yellow ink) having a large difference in index of refraction from the processing liquid and pigment inks Gr (cyan ink, black ink) having a small difference in index of refraction from the processing liquid. However, the number of classes into which ink is to be separated is not limited to this value. In this case, a similar effect to that in the embodiment described above can be achieved if a plurality of predetermined values or a plurality of mask patterns are used.

In this embodiment, furthermore, in addition to a pigment ink to be used for image formation as an ink to be used to form the outermost layer, a processing liquid for improving image performance (in the embodiment described above, scratch resistance) when using pigment inks is further used. Since the processing liquid is not basically used for image formation, the processing liquid is preferably substantially colorless and transparent. Alternatively, a material for improving the functions such as scratch resistance may be added to colored pigment inks, namely, some or all of light-colored pigment inks among pigment inks to be used for image formation, such as light cyan ink, light magenta ink, and light gray ink, and a resulting ink may be used as an ink to be used to form the outermost layer. In this case, additional components for one color, such as an ink tank and a recording head, are not required, thus significantly contributing to reduction in size and cost. It is to be understood that some or all of deep-colored pigment inks among pigment inks to be used for image formation may also serve as a processing liquid.

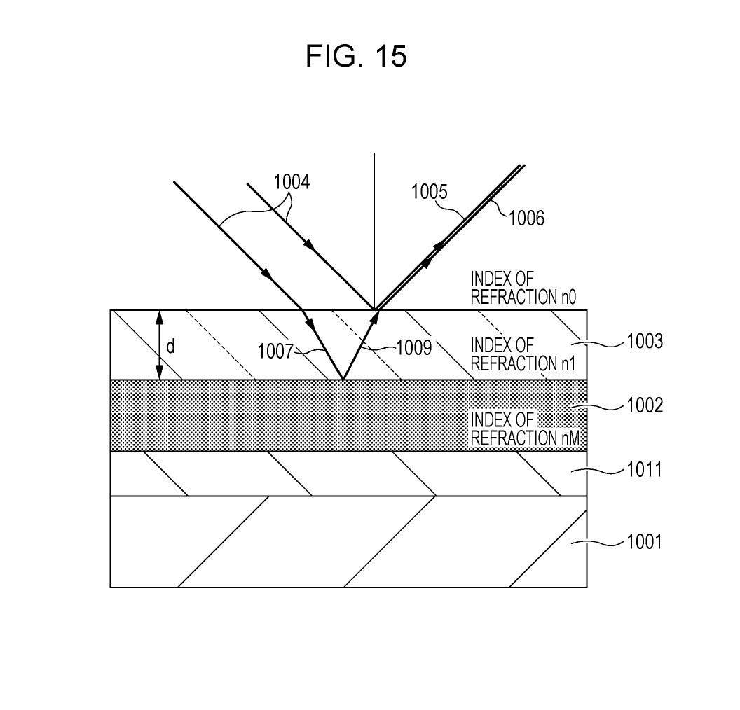

FIG. 15 is a diagram schematically illustrating a cross section of an example of a recorded matter recorded on a recording medium using a recording method according to this embodiment, which is taken along a plane perpendicular to the recording medium.

As illustrated in FIG. 15, a first layer 1011 having an index of refraction of A=nC is formed by cyan ink on or above a recording medium 1001. A second layer 1002 having an index of refraction of B=nM (nM<nC) is formed by ink B on the first layer formed by ink A. A third layer 1003 having an index of refraction of C=n1 (where n1>nC>nM), which forms as a surface layer of the recorded matter, is formed by ink C or a transparent resin material on the second layer 1002. Thus, the second layer 1002 of the ink B having a larger difference in index of refraction from the surface layer 1003 is formed closer to the third layer 1003 than the first layer 1011 of the ink A having a smaller difference. The second layer (magenta ink) 1002 having a larger difference in index of refraction from the third layer 1003 serving as a transparent layer is placed immediately below the third layer 1003, which is composed of a transparent resin. In this case, incident light 1004 is separated into light 1005 that is reflected from the surface of the third layer 1003 and light 1007 that travels through the third layer 1003. Since the difference between the index of refraction n1 of the third layer 1003 and the index of refraction nM of the second layer (magenta ink) 1002 is larger than the difference between the index of refraction n1 of the third layer 1003 and the index of refraction nC of the first layer 1011, the reflected light 1009 of the light 1007 on the interface can be larger than that when the first layer 1011 is formed immediately below the third layer 1003. The stacking structure described above facilitates propagation of reflected light from the interface, and the light 1005 and light 1006 interfere with each other on the surface of the transparent layer 1003, thereby reducing bronzing. A fourth layer formed by an ink D having a color different from a color of the ink A may be formed between the first layer 1011 and the recording medium 1001. Preferably, the recorded matter is formed in a region having an area that is greater than or equal to 50 percent of an area of a region that has been subjected to recording in the surface of the recording medium 1001. More preferably, the recorded matter is formed in a region having an area that is greater than or equal to 70 percent of an area of a region that has been subjected to recording in the surface of the recording medium 1001. Further, preferably, the recorded matter is formed in a region having an area that is greater than or equal to 90 percent of an area of a region that has been subjected to recording in the surface of the recording medium 1001.

### Second Embodiment

In the foregoing embodiment, to improve the scratch resistance of an image formed using pigment inks, the ink application order is controlled so that when the image is coated with a transparent layer formed of a processing liquid, a pigment ink Gr having a large difference in index of refraction from the transparent layer adjoins the transparent layer. As a result, a bronzing color of pigment ink can be reduced. In a second embodiment, a description will be made of a case where a light-colored pigment ink, rather than a transparent layer formed of a processing liquid, has a function for improving scratch resistance and an image is recorded so that the light-colored pigment ink forms the outermost layer of the image. In the foregoing embodiment, furthermore, the pigment ink that adjoins the transparent layer serving as the outermost layer is set using the difference in index of refraction. In this embodiment, however, a difference in color of reflected light, which can be easily measured as an optical characteristic and which is greatly correlated with the index of refraction, is used. That is, the ink application order is controlled so that a pigment ink Gr having a large difference in color of reflected light from the light-colored pigment ink layer serving as the outermost layer adjoins the light-colored pigment ink layer serving as the outermost layer. In addition, a method for controlling the ink application order in units of ink dots so that the light-colored pigment ink serving as the outermost layer and a deep-colored pigment ink adjoin each other in an optimum combination will also be described. Portions similar to those in the foregoing embodiment will not be described herein.

### Overall Configuration

An inkjet recording apparatus according to this embodiment is configured such that the sections regarding the processing liquid (H) are removed from the configuration illustrated in FIG. 1, and an overall configuration thereof will not be described herein. Each of the recording heads 22K, 22C, 22M, and 22Y has 1280 ejection ports arranged at a density of 1200 dpi in the direction crossing the main scanning direction, and a row of ejection ports of each color is formed (see FIG. 2B). Recording heads 22LC and 22LM are shifted downstream from the recording heads 22K, 22C, 22M, and 22Y in the paper feed direction in which recording media are transported, and each have 1280 ejection ports arranged in the direction crossing the main scanning direction (see FIG. 2B).

### Composition of Ink

The inks to be used in this embodiment are the inks described above, light magenta ink, and light cyan ink. Each of the light magenta ink and the light cyan ink contains a transparent resin material, which is used in the composition of a processing liquid, and therefore has a function for, similarly to the processing liquid, improving scratch resistance.

### Light Magenta Ink

### (1) Preparation of Dispersion Liquid

After 100 g of the polymer solution used in the magenta ink, 100 g of C.I. Pigment Red 122, and 800 g of ion-exchanged water were mixed and mechanically stirred for a predetermined period of time, the mixture was centrifuged to remove an undispersed material including coarse particles to prepare a magenta dispersion liquid. The obtained magenta dispersion liquid had a pigment concentration of 10 mass %.

### (2) Preparation of Ink

Ink was prepared by using the magenta dispersion liquid. The following components were added to the magenta dispersion liquid to obtain a desired concentration. The components were sufficiently mixed and stirred, and then filtered under pressure by a microfilter with a pore size of 2.5 μm (manufactured by Fuji Photo Film Co., Ltd.) to prepare a pigment ink having a pigment concentration of 4 mass %.

Note that a commercially available acrylic silicone copolymer is used as a resin for improving scratch resistance.

Magenta dispersion liquid: 8 parts

Acrylic silicone copolymer (trade name: SYMAC® US-450, manufactured by Toagosei Co., Ltd.): 5 parts

Glycerin: 10 parts

Diethylene glycol: 10 parts

Acetylene glycol EO adduct (manufactured by Kawaken Fine Chemicals Co., Ltd): 0.5 parts

Ion-exchanged water: 66.5 parts

### Light Cyan Ink

### (1) Preparation of Dispersion Liquid

After 200 g of the polymer solution used to prepare cyan ink, 100 g of C.I. Pigment Blue 15:3, and 700 g of ion-exchanged water were mixed and mechanically stirred for a predetermined period of time, the mixture was centrifuged to remove an undispersed material including coarse particles to prepare a cyan dispersion liquid. The obtained cyan dispersion liquid had a pigment concentration of 10 mass %.

### (2) Preparation of Ink

Ink was prepared by using the cyan dispersion liquid. The following components were added to the cyan dispersion liquid to obtain a desired concentration. The components were sufficiently mixed and stirred, and then filtered under pressure by a microfilter with a pore size of 2.5 μm (manufactured by Fuji Photo Film Co., Ltd.) to prepare a pigment ink having a pigment concentration of 2 mass %.

Note that a commercially available acrylic silicone copolymer is used as a resin for improving scratch resistance.

Cyan dispersion liquid: 4 parts

Acrylic silicone copolymer (trade name: SYMAC® US-450, manufactured by Toagosei Co., Ltd.): 5 parts

Glycerin: 10 parts

Diethylene glycol: 10 parts

Acetylene glycol EO adduct (manufactured by Kawaken Fine Chemicals Co., Ltd): 0.5 parts

Ion-exchanged water: 70.5 parts

### Characteristic Configuration

In this embodiment, a light-colored pigment ink forms the outermost layer of an image. A table given below shows bronzing when the light cyan ink and the light magenta ink were applied.

TABLE 3
Bronzing of inks

| Type of ink | Bronzing value (C*) | Bronzing color |
|---|---|---|
| Cyan ink | 35 | Red |
| Magenta ink | 30 | Red |
| Yellow ink | 4 | Blue |
| Light cyan ink | 15 | Red |
| Light magenta ink | 14 | Red |

As given in Table 3, light-colored pigment inks have smaller bronzing values than deep-colored pigment inks. The reason for this is that the light-colored pigment inks used in this embodiment contain a transparent resin material having a function for improving scratch resistance. For resin, compared to the pigment (coloring material), specular reflection light is reflected as a color similar to the light source color. That is, the wavelength dependence of spectral intensity is low. Therefore, it is considered that the light-colored pigment ink, which contains a larger amount of resin, has a smaller bronzing value. For this reason, a light-colored pigment ink having a small bronzing value is applied on top of a deep-colored pigment ink, that is, the light-colored pigment ink is used as the outermost layer of an image, thereby achieving the effect of reducing bronzing of the image.

In this embodiment, furthermore, the order in which pigment inks are to be applied is controlled using, in place of the difference in index of refraction, the difference in color of reflected light, which is highly correlated with the index of refraction and can be easily measured.

The index of refraction changes in accordance with the wavelength of light, and therefore has a wavelength dispersion property. Thus, when light enters diagonally, the angle at which light refracts differs from wavelength to wavelength, thus making the light visible as colored light when perceived by the eye. The physical principle of why the index of refraction differs from wavelength to wavelength is presented in many articles, and the description thereof is thus omitted. In an image created by forming a pigment ink layer formed of a monochromatic pigment ink on a recording medium, white light is made incident on the pigment ink layer at a certain angle. Then, the light is reflected with colors different from one pigment ink to another in accordance with the index of refraction. If two types of pigment inks are selected, when the color difference (ΔE) between the specular reflections of light of the two pigment inks is large, the difference in index of refraction is also large, resulting in interference being likely to occur. When the color difference between the specular reflections of light of the two pigment inks is small, the difference in index of refraction is also small, resulting in interference being less likely to occur. In this consideration, chromaticity was measured using Spectroradiometer CS-2000A manufactured by Konica Minolta Sensing Americas, Inc., to measure the colors of the specular reflections of light. The measurement device is not limited to that given as an illustrative example, and any measurement device capable of measuring the color of a specular reflection of light may be used.

A table given below shows the results of measuring color differences (ΔE) between light cyan ink and each deep-colored ink and between light magenta ink and each deep-colored ink. The presence/absence of interference when each deep-colored ink adjoins the light cyan ink or the light magenta ink serving as the outermost layer is also given. In the measurement of specular reflection light, the recording operation was performed by multi-path recording with eight scans in total, and a pigment ink was applied at 100% duty. In a visual evaluation of interference, after a deep-colored pigment ink was applied at 100% duty, a light-colored pigment ink was applied at 100% duty. In this consideration, glossy photo paper manufactured by CANON KABUSHIKI KAISHA (trade name: Glossy Photo Paper [thin] LFM-GP421R” was used as the recording medium.

TABLE 4
Color difference in specular reflection light
of ink and presence/absence of interference

| | | Color | |
|---|---|---|---|
| | | difference in | |
| | | specular | |
| Outermost | Adjoining | reflection | Presence/absence |
| layer | layer | light | of interference |
| Light cyan | Cyan ink | 10 | No interference |
| ink | | | occurred |
| Light cyan | Magenta ink | 28 | Interference |
| ink | | | occurred |
| Light cyan | Yellow ink | 20 | Slight |
| ink | | | interference |
| | | | occurred |
| Light cyan | Black ink | 18 | Slight |
| ink | | | interference |
| | | | occurred |
| Light magenta | Cyan ink | 25 | Interference |
| ink | | | occurred |
| Light magenta | Magenta ink | 9 | No interference |
| ink | | | occurred |
| Light magenta | Yellow ink | 17 | No interference |
| ink | | | occurred |
| Light magenta | Black ink | 12 | No interference |
| ink | | | occurred |

As given in Table 4, it is found that interference is likely to occur when the color difference in specular reflection light between the light-colored pigment ink layer serving as the outermost layer and its adjoining pigment ink layer is large, and interference is less likely to occur if the color difference is small. It is also found that the combination of inks that cause interference and the combination of inks that do not cause interference differ depending on the type of ink and depend upon the magnitude of the color difference in specular reflection light. Specifically, when light cyan ink forms the outermost layer, interference is likely to occur when magenta ink, yellow ink, or black ink adjoins it. When light magenta ink forms the outermost layer, interference is likely to occur when cyan ink adjoins it. In this manner, optimizing the pigment ink application order can reduce a bronzing color of a pigment ink image.

### Image Processing

A method for generating ejection data according to this embodiment will be described.

First, RGB multivalued image data is input from the host computer (image input unit) 28. The RGB multivalued image data is converted into multivalued image data respectively corresponding to a plurality of types of inks (K, C, M, Y, LC, LM) to be used for image formation. Then, the multivalued image data corresponding to the respective inks is expanded into binary image data for the corresponding inks in accordance with an index pattern stored in advance in the ROM 304. Because of the use of an index pattern, this binarization processing is also referred to as index pattern expansion processing. Through the index pattern expansion processing, binary image data for respectively applying a plurality of types of pigment inks is generated. In this embodiment, among a plurality of types of inks (K, C, M, Y, LC, LM), a pigment ink Gr having a large color difference in specular reflection light from the light cyan ink (or is different by a predetermined standard or more) is subjected to binarization processing using a similar index pattern. In addition, a pigment ink Gr having a large color difference in specular reflection light from the light magenta ink is subjected to binarization processing using another similar index pattern described below. The values of specular reflection light for pigment inks are stored in advance in the ROM 304.

Among the pigment inks used in this embodiment, as described above, magenta ink, yellow ink, and black ink were deep-colored pigment inks having a large color difference in specular reflection light from the light cyan ink. In addition, cyan ink was a deep-colored pigment ink having a large color difference in specular reflection light from the light magenta ink. Thus, the light cyan ink and its associated inks, i.e., the magenta ink, the yellow ink, and the black ink, may be subjected to binarization processing using similar index patterns. Further, the light magenta ink and the cyan ink may be subjected to binarization processing using other similar index patterns. However, for all the inks, index patterns similar to that for either light-colored pigment ink may not necessarily be used. For example, if the color difference in specular reflection light is small or if there is no deviation, binarization may be performed using another new index pattern which is not similar to the index pattern of the light-colored pigment ink.

Then, the binary image data of the plurality of types of pigment inks is subjected to mask pattern processing using a plurality of types of typically used mask patterns illustrated as an example in FIG. 9, which are prepared in the ROM 304, to generate ejection data in a format that can be transferred to the recording heads.

In accordance with the ejection data generated in the manner described above, pigment inks are ejected from the recording heads of the inkjet recording apparatus (image output unit) 30 using the multi-path recording method to form an image.

The index pattern expansion processing described above will now be described briefly.

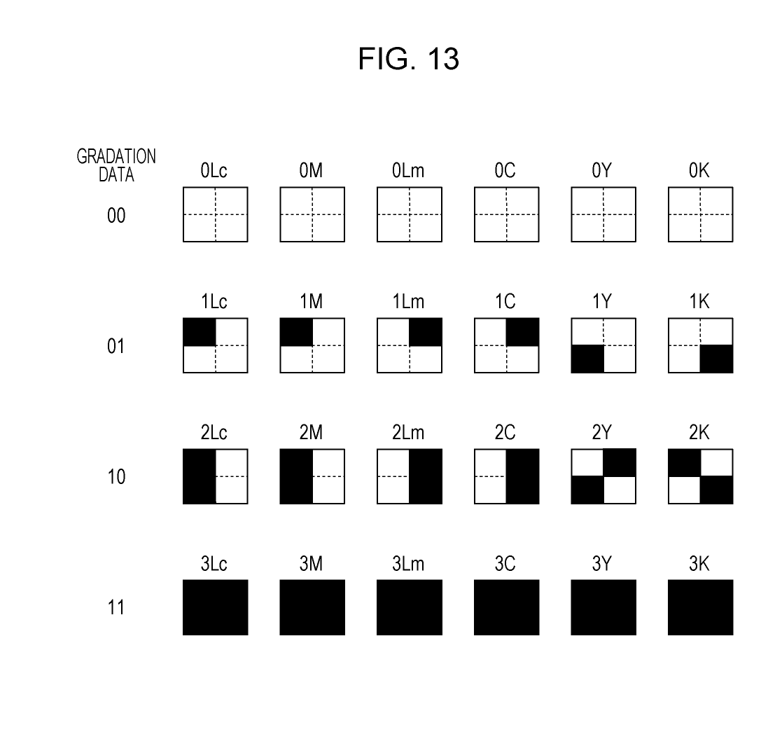

FIG. 13 is a schematic diagram illustrating general index pattern expansion processing. The index pattern expansion processing is processing for converting multivalued image data of several gradation levels (gradation data) input from a host computer (image input unit) into binary image data for determining recording or non-recording of dots that can be recorded by an inkjet recording apparatus (image output unit). In FIG. 13, multivalued values 00 to 11 of image data (gradation data) illustrated in the left part represent the values of 2-bit image data which is multivalued image data converted through image processing, namely, color conversion. In this embodiment, this gradation level of data has a resolution of 600 dpi. This unit of pixels (i.e., pixels input from the host computer and having several levels of gradation values) is hereinafter referred to as a “unit pixel”. Patterns illustrated in the right part of FIG. 13 in association with the respective values are patterns that actually determines recording or non-recording of dots, in which individual rectangles are arranged at a resolution of 1200 dpi (main scanning direction)×1200 dpi (sub-scanning direction). The unit of the rectangle (the minimum unit by which the inkjet recording apparatus actually determines recording or non-recording of each dot) is hereinafter referred to as a recording pixel. A black rectangle represents a recording pixel for which a dot is to be recorded, and a white rectangle represents a recording pixel for which a dot is not to be recorded. That is, in this embodiment, a region of one unit pixel corresponds to a region of 2×2 recording pixels. As can be seen in FIG. 13, as the value of the gradation data that each unit pixel possesses increases, the number of recording pixels (black rectangles) in the 2×2 recording pixels increases.

Dot arrangement according to this embodiment will be described hereinafter.

FIG. 13 illustrates index patterns respectively corresponding to the plurality of types of inks (K, C, M, Y, LC, LM) according to this embodiment. The dot arrangement corresponding to the value 10 of gradation data of black ink is indicated by symbol 2K. Similarly, the dot arrangements for cyan ink, magenta ink, yellow ink, light cyan ink, and light magenta ink are represented by symbols C, M, Y, LC, and LM, respectively. In this embodiment, the same index pattern was used for light cyan ink and magenta ink having a large color difference in specular reflection light from light cyan ink. Similarly, the same index pattern was used for light magenta ink and cyan ink having a large color difference in specular reflection light from light magenta ink. In addition, as a result of the evaluation of image quality other than bronzing, different index patterns were used for yellow ink and black ink.

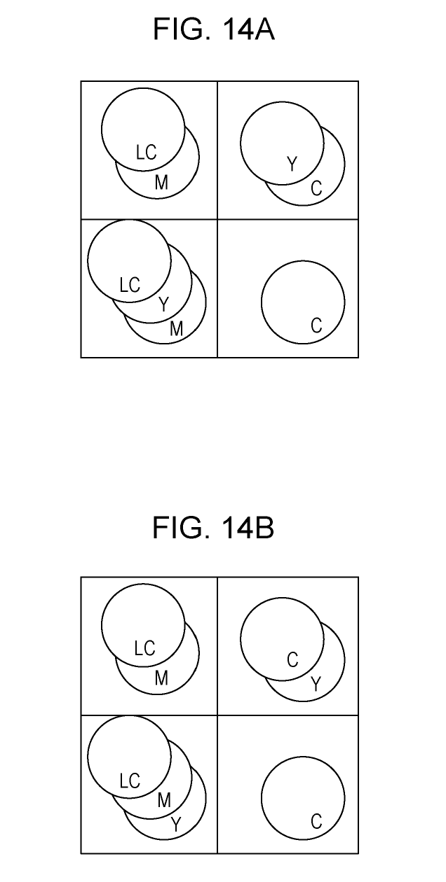

FIG. 14A illustrates the dot arrangement of an image in which, for example, a unit pixel is formed using light cyan ink, cyan ink, magenta ink, and yellow ink when all the gradation values of these inks are 10. With the configuration of the recording heads illustrated in FIG. 2B, magenta ink is selectively arranged so that it is highly probable that magenta ink adjoins the dots of light cyan ink which forms the outermost surface. Thus, the effect of making interference likely to occur and reducing bronzing can be achieved.

In this embodiment, since 2-bit multivalued image data is used, the number of gradation levels is four. As the resolution of the recording pixel is increased, for example, 4-bit multivalued image data can be generated for 2400×1200 dpi, and each unit pixel can have 4×2 recording pixels with nine gradation levels. In this case, a plurality of types of index patterns can be set. Thus, the degree to which dots overlap for each gradation level is controlled so that a dot arrangement with which interference is likely to occur is set for each pigment ink.

### Recording Operation

A recording operation for performing characteristic control according to this embodiment will be described. The term “characteristic control” means the control of the ink application order so that a pigment ink having a large color difference in specular reflection light from the light-colored pigment ink adjoins the outermost layer. In this example, a multi-path recording method with 16 scans in total is employed in which the light-colored pigment ink forms the outermost layer through eight scans and the remaining pigment inks also form image layers below the outermost layer through eight scans. The number of scans in the recording method and the application method is not limited.

Since the recording method described above is used, a specific recording method will not be described herein.

As described above, a recording method for applying a plurality of combinations of light-colored/deep-colored pigment inks can differ, as desired, in accordance with the color difference in specular reflection light between the light-colored pigment ink serving as the outermost layer and its adjoining deep-colored pigment ink. That is, using similar index patterns for the light-colored pigment ink serving as the outermost layer and a deep-colored pigment ink having a large color difference in specular reflection light from the light-colored pigment ink serving as the outermost layer, the ink application order can be controlled so that dots of an optimum combination of pigment inks adjoin. Since the color difference in specular reflection light is correlated with the difference in index of refraction, reflected light is strong on the interface between the outermost layer formed of a light-colored pigment ink and a pigment ink layer formed below the outermost layer, and interference on the surface of the outermost layer can reduce bronzing of the pigment inks.

While in this embodiment, ΔE is used as the color difference in specular reflection light, the difference in hue or the like may also be used because it is correlated with the difference in index of refraction.

In the description of this embodiment, furthermore, light-colored pigment ink (LC, LM) is used to form the outermost layer, and light cyan ink is a specific example of the ink used to form the outermost layer in a predetermined region (unit pixel). However, both light cyan ink and magenta ink may be used to form the outermost layer in a predetermined region. In this case, if the color of specular reflection light for the mixture of these colors is stored in advance, a pigment ink that is to adjoin the outermost layer can be determined. Since the recording heads used in this embodiment are configured such that a light-colored pigment ink is applied on top of a deep-colored pigment ink, light-colored pigment inks can be added together to form the outermost layer. The reason for this is that, unlike deep-colored pigment inks, only light-colored pigment inks contain a transparent resin material and serve as the processing liquid according to the foregoing embodiment. Alternatively, one of light-colored pigment inks may be focused, and a pigment ink that is to adjoin the outermost layer may be determined. In this case, interference is more likely to occur on the outermost layer of an image than in the related art, resulting in bronzing being reduced.

In this embodiment, furthermore, light cyan ink or light magenta ink for improving image performance (in the embodiment described above, scratch resistance) is used as ink to form the outermost layer among pigment inks used for image formation. A processing liquid that is substantially colorless and transparent may be added. Such a processing liquid may be recorded simultaneously with light cyan ink or light magenta ink, or may be recorded so as to coat such inks. In this case, optimum control may be performed using a combination of control operations used in the foregoing embodiment. In addition, instead of a light-colored pigment ink, a deep-colored pigment ink may be used as an ink to form the outermost layer.

### Third Embodiment

In the second embodiment, a light-colored pigment ink has a function for improving scratch resistance, and the ink application order is controlled in units of ink dots so that when an image is recorded so that a light-colored pigment ink forms the outermost layer of the image, an optimum deep-colored pigment ink adjoins each light-colored pigment ink. As a result, a bronzing color of pigment ink can be reduced. In a third embodiment, a description will be made of a case where the order in which deep-colored pigment inks are to be applied is controlled so that the probability that ink dots of an optimum combination of light-colored pigment ink and deep-colored pigment ink adjoin is increased. Portions similar to those in the foregoing embodiments will not be described herein.

### Overall Configuration

An overall configuration of an inkjet recording apparatus according to this embodiment, a configuration of a recording head, the composition of ink, etc., are substantially the same as those in the foregoing embodiments, and a description thereof is thus omitted.

### Image Processing

Next, a method for generating ejection data according to this embodiment will be described.

Specifically, first, RGB multivalued image data is input from the host computer (image input unit) 28. The RGB multivalued image data is converted into multivalued image data respectively corresponding to a plurality of types of inks (K, C, M, Y, LC, LM) to be used for image formation. Then, the multivalued image data corresponding to the respective inks is expanded into binary image data for the corresponding inks in accordance with an index pattern stored in advance in the ROM 304 (index pattern expansion processing). Through the index pattern expansion processing, binary image data for respectively applying a plurality of types of pigment inks is generated. In this embodiment, as described above, magenta ink, which is a pigment ink Gr having a large color difference in specular reflection light from light cyan ink, is subjected to binarization processing using the same index pattern as light cyan ink. Further, cyan ink, which is a pigment ink Gr having a large color difference in specular reflection light from light magenta ink, is subjected to binarization processing using the same index pattern as light magenta ink. Yellow ink and black ink are subjected to binarization processing using different index patterns.

Then, the binary image data of light-colored pigment inks is subjected to mask pattern processing using typically used mask patterns illustrated as an example in FIG. 9 among a plurality of types of mask patterns prepared in the ROM 304, to generate ejection data in a format that can be transferred to the recording heads. The second-half mask pattern illustrated in FIG. 10A is set for, among binary image data of deep-colored pigment inks, binary image data of magenta ink and cyan ink, which have a large color difference in specular reflection light from a light-colored pigment ink, so that it is highly probable that such inks adjoin a light-colored pigment ink. The first-half mask pattern illustrated in FIG. 10B is set for binary image data of the remaining inks, i.e., yellow ink and black ink. Then, through mask pattern processing, ejection data in a format that can be transferred to the recording heads is generated.

In accordance with the ejection data generated in the manner described above, pigment inks are ejected from the recording heads of the inkjet recording apparatus (image output unit) 30 using the multi-path recording method to form an image.

For example, in the second embodiment, the dot arrangement of an image of a unit pixel for the gradation value 10 when the image is formed using light cyan ink, cyan ink, magenta ink, and yellow ink is illustrated in FIG. 14A. In this embodiment, as illustrated in FIG. 14B, magenta ink, which has a large color difference in specular reflection light from light cyan ink, is selectively arranged so that it is more probable that magenta ink adjoins the dots of light cyan ink which forms the outermost surface. Thus, the effect of making interference likely to occur and reducing bronzing can be achieved.

As described above, a recording method for applying a plurality of combinations of light-colored/deep-colored pigment inks using an index pattern and a mask pattern can differ, as desired, in accordance with the color difference in specular reflection light between the light-colored pigment ink serving as the outermost layer and its adjoining deep-colored pigment ink. That is, similar index patterns are used for the light-colored pigment ink serving as the outermost layer and a deep-colored pigment ink having a large color difference in specular reflection light from the light-colored pigment ink serving as the outermost layer so that dots of an optimum set of pigment inks adjoin each other, and the ink application order can be controlled so that the deep-colored pigment ink is applied during the second half scans. This can increase the probability that dots of an optimum combination of pigment inks which cause interference to be likely to occur on the surface of the outermost layer adjoin each other, and can reduce bronzing of pigment inks.

In this embodiment, a mask pattern corresponding to each deep-colored pigment ink is set so as to be used over an entire image. However, an optimum mask pattern may be used for each predetermined region (e.g., each unit pixel, each recording pixel, etc.). In this case, the type of light-colored pigment ink (for example, light cyan ink, light magenta ink, the mixture thereof, etc.) to be used for each predetermined region may be determined, and a mask pattern for each deep-colored pigment ink may be set in accordance with the determination results. This can further increase the probability that dots of an optimum combination of pigment inks adjoin each other, compared to the foregoing embodiments, and can reduce bronzing based on interference on the surface of the outermost layer.

### Fourth Embodiment

In the foregoing embodiments, the ink application order is controlled so that a pigment ink having a large difference in index of refraction or a large color difference in specular reflection light from the pigment ink serving as the outermost layer adjoins the outermost layer. As a result, a bronzing color of pigment ink can be reduced. In a fourth embodiment, reflected light is finely split into different wavelengths, and the difference in reflection spectrum which represents reflectance for each wavelength as a function is used. Interface reflection is predicted to occur between two layers having largely different reflection spectra. Thus, the ink application order is controlled so that a pigment ink having a large difference in reflection spectrum from the pigment ink serving as the outermost layer adjoins the outermost layer. The difference in reflection spectrum can be determined by, for example, determining the absolute magnitude of the difference in reflection spectrum using the following equation, that is, by determining the value obtained by integrating the squared difference in reflection spectrum.

$$\begin{matrix} [ Math . 1 ] & \\ Δ R = {\int }_{380}^{780} {( {R}_{1} ( λ ) - {R}_{2} ( λ ) )}^{2} d λ \\ {R}_{1} \text{:} Reflectance of outermost layer \\ {R}_{2} \text{:} Reflectance of layer adjoining outermost layer \\ d \text{:} Thickness of outermost layer & ( formula 3 )\end{matrix}$$

A specific control method etc. are similar to those in the foregoing embodiments, and a description thereof is thus omitted.

A general spectral colorimeter (for example, Spectrophotometer CM-2600d manufactured by Konica Minolta Sensing Americas, Inc.) or the like may be used for ease-of-use measurement.

### Other Embodiments

In the foregoing embodiments, recording heads are configured such that ejection ports which form nozzles for ejecting pigment inks and ejection ports which form nozzles for ejecting a processing liquid are shifted with respect to each other in the direction (for example, sub-scanning direction) crossing the main scanning direction. However, recording heads may also be configured such that the ejection ports for both pigment inks and a processing liquid are arranged in the main scanning direction. In addition, the number of nozzles for ejecting a processing liquid may be larger than the number of nozzles for ejecting pigment inks, and the row of the former nozzles may be longer than the row of the latter nozzles. The same applies to ejection ports which form nozzles for ejecting light-colored pigment inks and ejection ports which form nozzles for ejecting deep-colored pigment inks.

As described above, the ink to be used for the outermost layer is a processing liquid in the first embodiment, and is light cyan ink and light magenta ink in the second embodiment. However, the type and number of inks to be used for the outermost layer are not limited. Deep-colored magenta ink or cyan ink may form the outermost layer. In this case, a deep-colored pigment ink, rather than a processing liquid or a light-colored pigment ink, may contain a transparent resin material. In addition, the type of ink that forms the outermost layer may differ for each predetermined region.

In the foregoing embodiments, furthermore, the ink application order in which the outermost layer, a pigment ink adjoining the outermost layer, and a pigment ink not adjoining the outermost layer, which are used in combination in two to three steps, are be applied is determined. However, the number of divisions of the ink application order is not limited, and the ink application order may be the order in which inks are to be applied in four steps. In addition, any of the foregoing embodiments may be applied to reflection on the interface between the second layer (pigment ink layer adjoining the outermost layer) and the third layer (pigment ink layer not adjoining the outermost layer). Further, if there are only two types of inks, the outermost layer and a pigment ink adjoining the outermost layer, to form an image of a predetermined region, or if there is only one type of ink for the outermost layer, the ink application order does not need to be changed, or cannot be changed. Thus, the original ink application order is used.

In the foregoing embodiments, furthermore, a processing liquid or a pigment ink to improve the scratch resistance function has been given as specific examples. However, a pigment ink and a processing liquid which are applicable in the present invention are not limited to the above-described liquid. A pigment ink and a processing liquid for improving not only the function described above but also some performance for an image, such as image quality including glossiness, and image durability including water resistance, alkali resistance, and weather resistance, may also be used. Such an ink and processing liquid may be made of a material such as a water-soluble resin, a water-degradable resin, or silicone oil.

In the foregoing embodiments, furthermore, among all the plurality of types of pigment inks to be used to form an image of a predetermined region, and a pigment ink adjoining a transparent layer or the outermost layer is determined. However, an ink adjoining the outermost layer may be determined from among a certain number of types of pigment inks. In addition, a plurality of types of pigment inks may be determined.

In the foregoing embodiments, furthermore, a pigment ink adjoining the outermost layer is determined in accordance with the difference in index of refraction, specular reflection light color, or reflection spectrum value, and the pigment ink application order is changed. When a pigment ink adjoining the outermost layer is determined using the difference in value, an ink having the largest difference may be determined, or all the inks for which the difference in value is greater than or equal to a threshold value may be determined as inks having a large difference.

If the total amount of ink to be applied to a predetermined region is smaller than a predetermined value, pigment inks (for example, cyan and magenta) may not overlap. The ejection data may be generated for each of a plurality of types of inks to be used for recording on the predetermined region so that liquid droplets of an ink having the largest difference in index of refraction from the index of refraction for the processing liquid that forms the outermost layer have the highest ratio of liquid droplets forming the second layer to a plurality of liquid droplets. Preferably, an ink having the largest difference in index of refraction from the index of refraction for the processing liquid that forms the outermost layer has the highest ratio of the number of liquid droplets covered by the processing liquid to the number of liquid droplets for each color in the predetermined region. For example, when ten droplets of magenta ink and ten droplets of cyan ink that form the outermost layer are arranged so as not to overlap each other, a processing liquid is applied to 80 percent of cyan ink, and 15 droplets of the processing liquid are ejected to less than 80 percent of magenta ink. In this case, it is effective to generate data for the processing liquid so that ten droplets of the processing liquid are applied to cyan ink and the remaining five droplets of the processing liquid is applied to magenta ink or the proportion of magenta ink is larger than the proportion of the processing liquid.

In the foregoing embodiments, furthermore, a processing liquid or a light-colored pigment ink fulfils its function when it is in the outermost surface. However, some inks may be ejected together with the other pigment inks during image formation, and may be contained in a pigment ink image layer formed below the outermost layer.

The present invention may be widely applied to various inkjet recording apparatuses configured to scan recording heads capable of ejecting inks and a processing liquid a plurality of times to form an image in a predetermined region on a recording medium using the inks and to coat the image with the processing liquid or a light-colored pigment ink. Therefore, the configuration and number of recording heads, etc. are not limited to those in the foregoing embodiments.

While in the present invention, a configuration for forming the outermost layer of an image using a processing liquid or a light-colored pigment ink has been described, an ink that forms the outermost layer may not necessarily be specified. In this case, the following control may be performed: An ink that forms the outermost layer is detected for each predetermined region where an image is to be formed, and a pigment ink that is to adjoin the ink that forms the outermost layer is determined. Then, the ink application order is changed.

In the foregoing embodiments, a pigment ink that is to adjoin the outermost layer is determined in accordance with the difference in index of refraction, specular reflection light color, or reflection spectrum value, and the pigment ink application order is changed. However, a threshold value used for determination may be changed and an application method may be changed in accordance with the type of recording medium (type of ink receiving layer such as highly absorptive ink receiving layer, or type per use such as glossy paper or matte paper) or the type of recording mode (such as draft mode or high-definition mode).

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-241439, filed Nov. 2, 2011, which is hereby incorporated by reference herein in its entirety.

1. A recorded matter recorded on a recording medium, comprising:
a first layer formed by an ink A on or above the recording medium, the first layer having an index of refraction A;
a second layer formed by an ink B on the first layer formed by the ink B, the second layer having an index of refraction B, where B<A; and
a third layer formed by an ink C or by a transparent resin material on the second layer, the third layer having an index of refraction C, where C>A, the third layer forming a surface layer of the recorded matter.

2. The recorded matter according to claim 1, wherein the ink B is magenta ink, and the ink A is cyan ink.

3. The recorded matter according to claim 1, wherein the third layer is formed by a transparent resin material.

4. The recorded matter according to claim 1, further comprising a fourth layer formed on a side of the first layer which is closer to the recording medium, the fourth layer being formed by an ink D having a color different from a color of the ink A.

5. The recorded matter according to claim 1, wherein the ink B and the ink A are pigment inks.

6. A recording medium having formed thereon the recorded matter according to claim 1, the recorded matter being formed in a region having an area that is greater than or equal to 50 percent of an area of a region that has been subjected to recording.

7. A recording medium having formed thereon the recorded matter according to claim 1, the recorded matter being formed in a region having an area that is greater than or equal to 70 percent of an area of a region that has been subjected to recording.

8. A recording medium having formed thereon the recorded matter according to claim 1, the recorded matter being formed in a region having an area that is greater than or equal to 80 percent of an area of a region that has been subjected to recording.

9. A recording method for forming a recorded matter on a recording medium, comprising:
applying a first layer formed by an ink A on or above the recording medium, the first layer having an index of refraction A;
applying a second layer formed by an ink B on the first layer, the second layer having an index of refraction B, where B<A;
applying a third layer formed by an ink C or a transparent resin material on the second layer, the third layer having an index of refraction C, where C>A, the third layer forming a surface layer of the recorded matter.

10. The recording method according to claim 9, wherein the ink B is magenta ink, and the ink A is cyan ink.

11. The recording method according to claim 9, wherein the third layer is formed by a transparent resin material.

12. The recording method according to claim 9, further comprising a fourth layer formed on a side of the first layer which is closer to the recording medium, the fourth layer being formed by an ink D having a color different from a color of the ink A.

13. The recording method according to claim 9, wherein the ink B and the ink A are pigment inks.

14. An image processing method comprising:
in order to form an image in a unit region of a recording medium by performing recording with a plurality of scans of a recording head, the recording head being capable of ejecting an ink A to form a layer having an index of refraction A on or above the recording medium, ejecting an ink B to form a layer having an index of refraction B on or above the recording medium, where B<A, and ejecting an ink C or a transparent resin material to form a layer having an index of refraction C, where C>A, to coat the layers formed by the ink A and the ink B on or above the recording medium,
determining an amount of the ink A and an amount of the ink B to be applied during each of a plurality of scans over the unit region; and
causing the recording head to perform recording on the recording medium in accordance with the determined amounts of the ink A and the ink B,
wherein in the determining, the amounts of the ink A and the ink B are determined so that a ratio of an amount of the ink B to be ejected during second half scans among the plurality of scans to an amount of the ink B to be ejected to the unit region is higher than a ratio of an amount of the ink A to be ejected during second half scans among the plurality of scans to an amount of the ink A to be ejected to the unit region.

15. The image processing method according to claim 14, wherein the ink B is magenta ink and the ink A is cyan ink.

16. The image processing method according to claim 14, wherein the layer having the index of refraction C is formed by a transparent resin material.

17. The image processing method according to claim 14, wherein the ink B and the ink A are pigment inks.

18. An image processing apparatus for forming an image in a unit region of a recording medium by performing recording with a plurality of scans of a recording head, the recording head being capable of ejecting an ink A to form a layer having an index of refraction A on or above the recording medium, ejecting an ink B to form a layer having an index of refraction B on or above the recording medium, where B<A, and ejecting an ink C or a transparent resin material to form a layer having an index of refraction C, where C>A, to coat the layers formed by the ink A and the ink B on or above the recording medium, the image processing device comprising:
a determining unit configured to determine an amount of the ink A and an amount of the ink B to be applied during each of a plurality of scans over the unit region; and
a controlling unit configured to cause the recording head to perform recording on the recording medium in accordance with the determined amounts of the ink A and the ink B,
wherein the determining unit determines the amounts of the ink A and the ink B so that a ratio of an amount of the ink B to be ejected during second half scans among the plurality of scans to an amount of the ink B to be ejected to the unit region is higher than a ratio of an amount of the ink A to be ejected during second half scans among the plurality of scans to an amount of the ink A to be ejected to the unit region.

19. The image processing method according to claim 18 wherein the ink B is magenta ink and the ink A is cyan ink.

20. The image processing apparatus according to claim 18, wherein the layer having the index of refraction C is formed by a transparent resin material.

21. The image processing apparatus according to claim 18, wherein the ink B and the ink A are pigment inks.

22. The image processing apparatus according to claim 18, further comprising the recording head.
